(19) United States
(12) Patent Application Publication
(10) Pub. No.: US 2022/0396655 A1
(43) Pub. Date: Dec. 15, 2022

(54) PROCESS FOR PREPARING POLYURETHANES HAVING A HIGH REACTION ENTHALPY

(71) Applicant: Covestro Intellectual Property GmbH & Co. KG, Leverkusen (DE)

(72) Inventors: Mathias MATNER, Neuss (DE); Thomas KOENIG, Leverkusen (DE); Bernd GARSKA, Köln (DE); Stephan SCHUBERT, Leverkusen (DE); Dirk ACHTEN, Leverkusen (DE); Rainer BELLINGHAUSEN, Odenthal (DE); Claudia HOUBEN, Heinsberg (DE)

(21) Appl. No.: 17/782,300

(22) PCT Filed: Dec. 10, 2020
(86) PCT No.: PCT/EP2020/085473

§ 371 Date: Jun. 3, 2022

(30) Foreign Application Priority Data
Dec. 17, 2019 (EP) 19216835.9

(51) Int. Cl. C08G 18/08; C08G 18/10; C08G 18/32; C08J 3/12

(52) U.S. Cl. CPC C08G 18/0895; C08G 18/10; C08G 18/3206; C08J 3/12; C08J 2375/04

(57) ABSTRACT

The invention relates to a multi-stage process for the continuous preparation of thermoplastic polyurethanes by reacting one or more aliphatic, cycloaliphatic and/or araliphatic diols with one or more aliphatic, cycloaliphatic and/or araliphatic diisocyanates, wherein the total reaction enthalpy is ≤−500 kJ/kg over all the process stages at a molar ratio of diol to diisocyanate of 1.0:1.0.

The invention relates to a multistage process for continuous, solvent-free preparation of thermoplastic polyurethanes by reaction of one or more diols with one or more diisocyanates comprising aliphatic, cycloaliphatic and/or araliphatic diisocyanates, where the isocyanate component and the diol component are selected such that, when they are reacted in a molar ratio of 1.0:1.0, the overall enthalpy of reaction over all process stages is from −900 kJ/kg to −500 kJ/kg, determined according to DIN 51007:1994-06.

Owing to their excellent physical properties, polyurethanes and especially thermoplastic polyurethanes have been used for a wide variety of different end uses for many years. In spite of the broad usability of polyurethanes, there are fields of application in which other plastics, for example polyamide plastics, are used because there are no polyurethanes having suitable physical properties available or these can be provided only with difficulty.

Polyurethanes formed from short-chain aliphatic diols and aliphatic polyisocyanates have properties comparable to or better than the polyamide plastics. However, it has not yet been possible to produce them satisfactorily on the industrial scale since it has not been possible to solve crucial chemical engineering problems to date. Owing to the high density of reactive groups, the polyaddition of short-chain aliphatic diols with aliphatic polyisocyanates has high exothermicity/enthalpy of reaction, which, in the event of inadequate removal of heat, leads to damage up to and including reformation of monomers and to destruction (ashing) of the polyurethane.

U.S. Pat. No. 2,284,637 discloses a batchwise process for preparing linear polyurethanes from diisocyanates or dithioisocyanates and diols or thiols. For this purpose, the co-reactants are converted in the presence of solvents, and in solvent-free systems.

U.S. Pat. No. 3,038,884 discloses polyurethanes derived from 2,2,4,4-tetramethylcyclobutane-1,3-diol which have a higher melting point and improved thermal stability compared to polyurethanes having no cyclic groups in the polymer chain. For this purpose, the co-reactants are converted in the presence of solvents, and in solvent-free batchwise systems.

O. Bayer (Angew. Chem. 1947, 59, 257-288) discloses the preparation of polyurethanes from aliphatic diisocyanates and aliphatic diols in a batchwise process, especially a polyurethane formed from hexamethylene diisocyanate and butane-1,4-diol (Perlon U, Igamid U), which is obtained as a fine, sandy powder from a precipitation polymerization in dichlorobenzene. It is pointed out that the polyaddition reaction is associated with significant exothermicity and that, in the case of a solvent-free reaction, the temperature of the melt has to be allowed to rise to about 200° C.

DE728981 and U.S. Pat. No. 2,511,544 disclose a batchwise process for reaction of diisocyanates with diols and/or diamines to give polyurethane or polyureas in a solvent-containing or solvent-free process.

A disadvantage of the above-described batchwise processes is that they can be scaled up from the pilot plant scale only with difficulty. Particularly in the case of systems that have high exothermicity of reaction with an enthalpy of reaction of ≤−500 kJ/kg, the adiabatic rise in temperature is problematic and the removal of heat is inadequate owing to the distinctly smaller ratio of cooling area available to the volume of the product on a large scale. Proceeding from monomers at a temperature sufficient for uncatalysed light-off of the reaction (>50° C.), the temperature of the reaction products would rise to well above 300° C. in adiabatic mode. The preparation and processing of polyurethanes at temperatures of >200° C. leads to losses of quality owing to a multitude of thermal side reactions. Excessively high product temperatures can in principle be prevented by a batchwise mode of operation in which at least one of the two monomers is gradually metered in in accordance with the cooling output of the reactor. However, there are technical limitations on cooling of high-viscosity polymers in batch apparatuses by virtue of the surface area of the heat transferrer and the flow rate. Long residence times in combination with high temperatures increase the number of unwanted side reactions and have an adverse effect on the product properties.

In industrial practice, preference is given to continuous production processes since it is easier here to conduct scale-up operations, and greater amounts can be produced with constant quality.

The production of pellets from thermoplastics after a batchwise process results in the need to keep the fusible polymer at high temperature until the batch vessel is empty. For thermally sensitive products, this results in a profile of product properties that changes continuously over the granulation process/granulation time.

It is also difficult to impossible to apply process procedures from batchwise processes to continuous processes. Particular attention from a chemical engineering point of view is paid to the controlled removal of the heat of reaction released, which means that reactions with high exothermicity can be handled only with difficulty.

The use of solvents is likewise disadvantageous since residual solvents remaining in the product can be released into the environment and can cause unwanted properties, for example odour, toxicity and/or a deterioration in the mechanical properties. The complete removal of residual solvents from a polymer cannot be accomplished in principle; the removal thereof down to a particular limit is fundamentally associated with elevated technical complexity and energy expenditure.

U.S. Pat. No. 5,627,254 discloses a continuous process for preparing thermoplastic urethanes from diisocyanates, short-chain polyethylene glycols, butanediol and more than 25% by weight of diols having a high molecular weight. The polyaddition product of methylene diphenyl diisocyanate and butanediol is likewise described. For this purpose, the components are converted in the presence of a catalyst in a twin-screw extruder. However, in the case of reactions of aromatic isocyanates with aliphatic polyols, the tendency to troublesome side reactions is very much smaller than in the case of corresponding conversions of aliphatic isocyanates. It is therefore generally not possible to apply such methods to essentially aliphatic reactants.

It was therefore an object of the present invention to provide a continuous, solvent-free process for polyurethane production that for the first time enables performance of the polyaddition reaction with high negative enthalpy of reaction per kg of reaction mixture on the industrial scale.

This object is achieved by a continuous,

solvent-free multistage process for preparing thermoplastic polyurethanes by reacting the following components:

A) one or more diols,

B) one or more diisocyanates including aliphatic, cycloaliphatic and/or araliphatic diisocyanates,

C) optionally one or more catalysts, and

D) optionally further auxiliaries or additives,

where at least one diol of component A has a molecular weight of 62 g/mol to 250 g/mol, where at least one hydroxy-terminated prepolymer is formed from the total amount or a first portion of component A and a first portion of component B in at least one process stage of the multistage process, where the sum total of all portions of component A or the sum total of all portions of component B over all process stages of the multistage process together is the total amount of component A or component B used, characterized in that components A and B are selected such that, when they are converted in a molar ratio of 1.0:1.0, the overall enthalpy of reaction over all process stages is from −900 kJ/kg to −500 kJ/kg, determined to DIN 51007:1994-06.

The overall enthalpy of reaction is determined according to DIN 517 June 1994 by heating 20 mg-30 mg of a mixture of component A and component B in a glass ampoule that has been sealed gas-tight at 3 K/min from −50° C. to +450° C., determining the difference between the temperature of the mixture and the temperature of an inert aluminium oxide reference by means of thermocouples, with component A and component B present in the mixture in a molar ratio of 1.0:1.0.

The advantage of the process according to the invention is that the temperature of the reaction mixture in the inventive execution can be very well controlled and there is therefore no substantial heat-related damage, for example speck formation or discolouration in the polyurethane product. In addition, the process according to the invention enables good scalability from the laboratory to an industrial scale.

“Overall enthalpy of reaction” in the context of the present invention is understood to mean the mass-specific change in enthalpy that proceeds in the polymerization reaction (polyaddition) of component A with component B in total over all process stages and without dilution, at a molar ratio of component A to component B of 1.0:1.0. The enthalpy of reaction is reported here in kJ per kg of the overall reaction mixture of component A and component B, at a molar ratio of component A to component B of 1.0:1.0. A reaction with a negative enthalpy of reaction is described as an exothermic reaction, meaning that energy in the form of heat is released in the course of the reaction.

A “solvent-free process” in the context of the present invention is understood to mean the reaction of components A and B without additional diluents, for example organic solvents or water, meaning that components A and B are preferably reacted with one another in undiluted form. Components C and/or D may optionally be present in suitable diluents and be added as a solution to components A and/or B. In the context of the present invention, the process is still considered to be solvent-free when the solvent content is up to 1% by weight, preferably up to 0.1% by weight, even more preferably up to 0.01% by weight, based on the total weight of the reaction mixture. A solvent is understood to mean a substance in which at least one of components A and B and optionally C and/or D can be dissolved, dispersed, suspended or emulsified, but which does not react with any of components A and B and optionally C and/or D or with the polymer and the prepolymer(s). In the context of the present invention, any non-reactive prepolymer and/or non-reactive polymer which does not react with any of components A and B and optionally C and/or D or with the polymer and the prepolymer(s) in the reaction mixture is not regarded as “solvent”.

In the context of the present invention, a “non-reactively terminated prepolymer” is understood to mean a prepolymer in which the reactive groups (NCO groups or OH groups) have been converted by reaction with suitable co-reactants (chain terminators) to chemical groups that do not react either with NCO groups or with OH groups under the reaction conditions mentioned. Suitable chain terminators are, for example, monoalcohols such as methanol, monoamines such as diethylamine, and monoisocyanates such as butyl isocyanate. The molar proportion of the chain terminators may, for example, be from 0.001 mol % to 2 mol % and preferably from 0.002 mol % to 1 mol %, based in each case on the total molar amount of the corresponding monomer component.

In the context of the present invention, “process stage” means the technical implementation of at least one basic operation, such as mixing, reacting, transporting, heat transfer etc., in combination with the dosage of at least one portion of component A and/or B and/or a hydroxy-terminated prepolymer and/or an NCO-terminated prepolymer. The process stage takes place in at least one given apparatus with a defined throughput. An apparatus includes the reactors, machinery, pipelines and measurement and control devices required for the purpose. One process stage can be conducted in one or more apparatuses. Reactors that can be used for polymer reactions are known to the person skilled in the art and are described, for example, in Moran, S. and Henkel, K.-D. 2016, Reactor Types and Their Industrial Applications, Ullmann's Encyclopedia of Industrial Chemistry, 149.

“Continuous processes” in the context of the invention are those in which the feeding of the reactants during a continuous production in at least one apparatus and the discharge of the products from at least one identical or different apparatus take place simultaneously, whereas, in batchwise processes, the feeding of the reactants, the chemical conversion and the discharge of the products generally take place successively in time. The continuous procedure is usually economically advantageous since plant shutdown times as a result of filling and emptying processes are avoided.

The person skilled in the art is aware that polymers and hence also prepolymers are not present as isolated species in polyurethane chemistry, but rather always as mixtures of molecules having different numbers of repeat units and hence different molecular weights and possibly also different end groups. Both the number of repeat units per molecule and possibly the end groups generally have a statistical distribution.

In the context of the present invention, the term “prepolymer” is understood to mean all reaction products or reaction product mixtures of components A, B and optionally C and D in which the molar ratio of the amounts of component B to component A used is between 0.1:1.0 and 0.95:1.0, or in which the molar ratio of the amounts of component A to component B used is between 0.1:1.0 and 0.95:1.0.

In the context of the present invention, a “hydroxy-terminated prepolymer” is understood to mean a prepolymer mixture in which at least 90% (by number) of the ends of the molecule have a hydroxyl group and the remaining 10% (by number) of ends of the molecule have further hydroxyl groups, NCO groups and/or non-reactive groups. A “non-reactive group” in the context of the present invention is understood to mean a group that, under the reaction conditions according to the invention, reacts neither with NCO groups nor with OH groups within a unit of time that corresponds to the reaction time according to the invention. A non-reactive group can be converted, for example, from a reactive NCO group or OH group by reaction with suitable co-reactants (chain terminator) to a non-reactive group. Suitable chain terminators are all monofunctional compounds that react under the reaction conditions according to the invention either with an isocyanate group or with a hydroxyl group, for example monoalcohols such as methanol, monoamines such as diethylamine, and monoisocyanates such as butyl isocyanate. The hydroxy-terminated prepolymer may have, for example, a hydroxyl group at one end of the molecule and, for example, an alkyl group at the other end(s) of the molecule. If a hydroxy-terminated prepolymer is mentioned in the context of the present invention, this always means a mixture of the at least one hydroxy-terminated prepolymer and a non-reactively terminated prepolymer. In addition, on the basis of the statistics of the reaction, disregarding side reactions, it may also be a mixture of non-hydroxy-terminated up to di-hydroxy-terminated prepolymers. Preferably, it is predominantly a mixture of di-hydroxy-terminated prepolymers. According to the invention, the at least one hydroxy-terminated prepolymer may also be a mixture of at least one hydroxy-terminated prepolymer and at least one non-reactively terminated prepolymer.

In a preferred embodiment of the process according to the invention, in at least one process stage, some of the overall enthalpy of reaction that arises is removed before the next process stage is reached. Preferably, in one process stage, from 25% to 98%, more preferably from 30% to 95% and even more preferably from 35% to 90% and most preferably from 40% to 85% of the overall enthalpy of reaction that arises is removed before the thermoplastic polyurethane is complete. Preferably, a large portion of the enthalpy of reaction removed is removed by heat conduction in the preparation of the at least one hydroxy-terminated prepolymer and/or of a mixture of at least one hydroxy-terminated prepolymer and at least one non-reactively terminated prepolymer.

In a preferred embodiment of the process according to the invention, the overall enthalpy of reaction over all process stages is in the range from −900 kJ/kg to −550 kJ/kg, preferably in the range from −900 kJ/kg to −580 kJ/kg, more preferably in the range from −900 kJ/kg to −600 kJ/kg, even more preferably in the range from −900 kJ/kg to −650 kJ/kg, according to DIN 51007:1994-06, when components A and B are reacted with one another in a molar ratio of 1:1. Corresponding enthalpies of reaction are determined by means of screening differential thermal analysis (DTA) according to DIN 51007 (June 1994). In this process, the corresponding monomers are mixed in a molar ratio of 1:1 and the enthalpy of reaction is determined during a particular temperature profile. The temperature profile used here starts at −50° C. and ends at +450° C. The heating rate used is 3 K/min. The inert reference used is aluminium oxide.

In a preferred embodiment of the process according to the invention, there is an overall molar ratio of component A to component B of 1.0:0.95 to 0.95:1.0.

According to the invention, component A and component B are reacted continuously with one another, optionally in the presence of components C and D. The process stages for production of the thermoplastic polyurethanes can be conducted in a single apparatus or in a multitude of apparatuses. For example, one process stage can first be conducted in a first apparatus (e.g. loop reactor or coolable mixer) and then the reaction mixture can be transferred into a further apparatus (e.g. extruder or other high-viscosity reactors) in which the reaction is continued.

The average residence time in the at least one process stage for preparation of the hydroxy-terminated prepolymer is between 5 seconds and 90 minutes, preferably between 10 seconds and 60 minutes, more preferably between 30 seconds and 30 minutes, based in each case on one process stage.

In at least one process stage in the multistage process, at least one hydroxy-terminated prepolymer is formed from the entirety or a first portion of component A and a first portion of component B. According to the invention, the at least one hydroxy-terminated prepolymer may also be a mixture of at least one hydroxy-terminated prepolymer and at least one non-reactively terminated prepolymer.

In a further preferred embodiment of the process according to the invention, the at least one hydroxy-terminated prepolymer is formed in at least one process stage from the entirety of component A and a first portion of component B. Preferably, the first portion of component B is from 40% to 95%, preferably from 60% to 95%, more preferably from 75% to 93%, based in each case on the total molar amount of component B used in the process.

The total amount of component A can be reacted with a first portion of component B, for example, in a first apparatus in order thus to form the at least one hydroxy-terminated prepolymer.

In one or more subsequent steps, further portions of component B, i.e. a second, third etc. portion, may then be added in order to form further hydroxy-terminated prepolymers, generally of higher molecular weight, according to the invention. The further portions of component B can be added in the first apparatus or the reaction mixture from the first apparatus can be transferred to a second apparatus and reacted with a second portion of component B therein. All further portions can then be added, for example, in the second apparatus, or the reaction mixture is transferred after each reaction with a portion of component B to a next apparatus, where it is reacted with a further portion of component B, until the total amount of component A has been reacted with the total amount of component B. The separate sequential addition of component B in terms of space and/or time has the advantage that, as a result, the heat of reaction released can be generated stepwise and hence can be better removed and/or utilized, for example in order to preheat components A and B before they are fed to the reactor. In the individual formation steps, it is also possible to add inventive amounts of non-reactively terminated prepolymers, one or more NCO-terminated prepolymers and/or chain terminators, for example monoalcohols. According to the invention, the at least one hydroxy-terminated prepolymer may also be a mixture of at least one hydroxy-terminated prepolymer and at least one non-reactively terminated prepolymer.

In the context of the present invention, an “NCO-terminated prepolymer” is understood to mean a polymer or prepolymer in which at least 90% (by number) of the ends of the molecule have an NCO group and the remaining 10% (by number) of ends of the molecule have further NCO groups, hydroxyl groups and/or non-reactive groups. If an NCO-terminated prepolymer is mentioned in the context of the present invention, this may also be a mixture of NCO-terminated prepolymers or a mixture of NCO-terminated prepolymers and non-reactively terminated prepolymers. Preferably, it is a mixture of NCO-terminated prepolymers. The NCO-terminated prepolymers can be obtained by reacting a portion of component A with a portion of component B, where component B is in excess. The polyaddition can be effected in the presence of components C and D. The temperatures for formation of the at least one NCO-terminated prepolymer by the process according to the invention can be selected depending on the compounds used. However, it is preferable here when the reaction is conducted at temperatures of ≥60° C. to ≤260° C., preferably of ≥80° C. to ≤250° C., more preferably of ≥100° C. to ≤245° C. and most preferably of ≥100° C. to ≤240° C. The NCO functionality has a statistical distribution and the average NCO functionality of the NCO-terminated prepolymer is between 1.8 and 2.2, preferably between 1.9 and 2.1 and most preferably between 1.95 and 2.05. The at least one NCO-terminated prepolymer may be a mixture of at least one NCO-terminated prepolymer and at least one non-reactively terminated prepolymer, where the NCO functionality has a statistical distribution and the average NCO functionality of the NCO-terminated prepolymer is between 1.8 and 2.2, preferably between 1.9 and 2.1 and most preferably between 1.95 and 2.05. If the at least one NCO-terminated prepolymer has a tendency to crystallize and has a melting point, the reaction is preferably conducted within a temperature range from 30 K below to 150 K above the melting point, preferably from 15 K below to 100 K above, more preferably from 10 K below to 70 K above, the melting point of the at least one NCO-terminated prepolymer.

In a particular embodiment, in every process stage, >50%, preferably >70% and more preferably >85% and most preferably >90% of the theoretical conversion of component B with component A and/or the at least one NCO-terminated prepolymer and/or the at least one hydroxy-terminated prepolymer is obtained.

In a further preferred embodiment of the process according to the invention, the at least one hydroxy-terminated prepolymer is formed in at least one process stage from a first portion of component A and a first portion of component B, where the molar ratio of the portions of components B and A used is from 0.65:1.0 to 0.98:1.0, preferably from 0.70:1.0 to 0.97:1.0, more preferably from 0.75:1.0 to 0.96:1.0 and most preferably 0.75:1.0 to 0.95:1.0, and where the first portion A used is at least 50%, preferably 70%, more preferably 90%, based on the total molar amount of component A used in the process.

In one or more subsequent process stages, further portions of component A and of component B may then be added in order to form further hydroxy-terminated prepolymers, generally of higher molecular weight, according to the invention. Preferably, no NCO-terminated prepolymer is formed from the at least one hydroxy-terminated prepolymer by addition of a further portion of component B. NCO-terminated prepolymers that are formed transiently in the course of the reaction in a statistical manner but are unstable are not counted here. The further portions of components A and B, optionally at least one hydroxy-terminated prepolymer and/or at least one NCO-terminated prepolymer and any chain terminators such as monoalcohols can also be introduced into further apparatuses, i.e. a second, third etc. apparatus, where each can be converted to a further prepolymer. According to the invention, the at least one hydroxy-terminated prepolymer may also be a mixture of at least one hydroxy-terminated prepolymer and at least one non-reactively terminated prepolymer.

In a further preferred embodiment of the process of the invention, components A and B and/or abovementioned prepolymers (hydroxy-terminated prepolymers, non-reactively terminated prepolymers) and/or compatible mixtures thereof are supplied to the reaction mixture at a temperature at least 30 K, preferably at least 50 K and more preferably 100 K below that of the reaction mixture. This has the advantage that some of the enthalpy of reaction is removed by the heating of components A and B and/or abovementioned prepolymers.

The hydroxy-terminated prepolymer or the mixture containing at least one hydroxy-terminated prepolymer may have a low or high viscosity in the melt under reaction conditions. A low viscosity is, for example, 0.1 Pa*s; a high viscosity is, for example, 500 Pa*s. What is being considered here is the Newtonian limiting viscosity at low shear rates. A low viscosity of the hydroxy-terminated prepolymer or mixture compared to that of the thermoplastic polyurethane has the advantage that the heat transferrers used can work efficiently and it is possible to use heat transferrers of low construction size or surface area. In addition, in the flow-through heat transferrers that are used with preference, a low pressure drop arises compared to that which occurs in the processing of higher-viscosity prepolymers. Preferably, the viscosity of the hydroxy-terminated prepolymer from the first process stage or of the mixture of at least one hydroxy-terminated prepolymer and at least one non-reactively terminated prepolymer is in the range from 0.1 Pa*s to 10 Pa*s, determined in the melt under the typical process conditions with regard to process temperature and shear.

In a further preferred embodiment, the determination or calculation of the viscosity is preferably effected in the process, for example via the measurement of pressure drops in pipeline sections or in static mixers. For circular pipeline sections, for laminar flow, the Hagen-Poiseuille equation for calculation of pressure drops (Δp in Pascal) in the form of

$$Δ p = \frac{128}{π} \frac{\dot{V}}{{D}^{3}} η \frac{L}{D}$$

(\dot{V} volume flow rate in cubic metres per second, D internal diameter of the tube through which the flow passes in metres, π≈3.14159 . . . pi, L length of the pipe in metres, η viscosity in Pascal seconds) can be rearranged to the determining equation for viscosity

$$η = \frac{π}{128} \frac{{D}^{4}}{\dot{V} L} Δ p$$

Preferably, the enthalpy of reaction removed is removed with the aid of heat transferrers that release this enthalpy of reaction as heat to a heat transfer medium. This heat transfer medium may, for example, be water in the liquid state, evaporating water or heat transfer oil, for example Marlotherm SH (from Sasol) or Diphyl (from Lanxess), in the liquid state.

The heat transfer medium on entry into the heat transferrer is preferably at a temperature sufficiently high that blockages resulting from crystallization and/or solidification of the reaction mixture are avoided.

The heat transfer medium can also be used in order to preheat the product stream in the heat transferrer at first to a temperature at which the reaction commences.

The heat transferrers may be designed in various ways. For example, they may be shell and tube heat transferrers having empty pipes or shell and tube heat transferrers having internals for improvement of heat transfer (e.g. static mixers such as those of the Kenics type, SMX from Sulzer or SMXL from Sulzer or CSE-X from Fluitec), or they may be, for example, plate heat transferrers, or, for example, they may be temperature-controllable static mixers that may, for example, be of the SMR type (from Sulzer) or the CSE-XR type (from Fluitec).

The temperatures for formation of the at least one hydroxy-terminated prepolymer by the process according to the invention can be selected depending on the compounds used. However, it is preferable here when the reaction is conducted at temperatures of ≥40° C. to ≤260° C., preferably of ≥60° C. to ≤250° C., more preferably of ≥100° C. to ≤240° C., especially preferably of ≥120° C. to ≤220° C. In this context, brief (<60 seconds) deviations in the reaction temperature from the abovementioned ranges experienced by the product during the reaction are tolerated.

If the at least one hydroxy-terminated prepolymer has a tendency to crystallize and has a melting point, the reaction is preferably conducted within a temperature range from 30 K below to 150 K above the melting point, preferably from 15 K below to 100 K above, more preferably from 10 K below to 70 K above, the melting point of the at least one hydroxy-terminated prepolymer.

In a further preferred execution, the hydroxy-terminated prepolymer has an average OH functionality calculated from the functionalities of the reactants of 1.8 to 2.1, preferably 1.95 to 2.05, more preferably 1.97 to 2.0, most preferably 1.975 to 2.0, based in each case on the molar amount of the overall prepolymer mixture.

In at least one further process stage, the at least one hydroxy-terminated prepolymer is converted to the thermoplastic polyurethane.

In a preferred embodiment of the process according to the invention, in at least one further process stage that follows the formation of the at least one hydroxy-terminated prepolymer, the at least one hydroxy-terminated prepolymer is reacted with a further portion of component B to give the thermoplastic polyurethane. Preferably, the further portion of component B is from 5% to 60%, preferably from 5% to 40%, more preferably from 7% to 25%, based in each case on the total molar amount of component B used in the process, with the proviso that the sum total of all portions of component B over all process stages of the multistage process together is the total molar amount of component B used. Either the at least one hydroxy-terminated prepolymer can be reacted all at once with the total amount of component B remaining or it is at first reacted only with a portion of component B and then further portions of component B are fed in stepwise and reacted until the total amount of component B has been consumed. Here too, stepwise conversion has the advantage that the course of the reaction can be better controlled, the thermoplastic polyurethane can be built up selectively and the heat of reaction can be better removed.

In a preferred embodiment of the process according to the invention, in at least one further process stage that follows the formation of the at least one hydroxy-terminated prepolymer, the at least one hydroxy-terminated prepolymer is reacted with a second portion of component B and a second portion of component A to give the thermoplastic polyurethane, with the proviso that the sum total of all portions of component A and the sum total of all portions of component B over all the process stages of the multistage process together is the total molar amount of component A or component B used. Either the at least one hydroxy-terminated prepolymer can be reacted all at once with the total amount of component B and of component A remaining or it is at first reacted only with a second portion of component B and then further portions of component B are fed in stepwise, or it is reacted at first only with a second portion of component A and then further portions of component A are fed in stepwise, or further portions of component A and further portions of component B are added and reacted together or alternately until the total amount of component B and component A has been consumed. Here too, stepwise conversion has the advantage that the course of the reaction can be better controlled, the thermoplastic polyurethane can be built up selectively and the heat of reaction can be better removed.

In a preferred embodiment of the process according to the invention, the at least one hydroxy-terminated prepolymer is formed in at least one process stage from a first portion of component A and a first portion of component B, and, in at least one further process stage that follows the formation of the hydroxy-terminated prepolymer, the at least one hydroxy-terminated prepolymer is reacted with at least one NCO-terminated prepolymer to give the thermoplastic polyurethane, where the at least one NCO-terminated prepolymer is formed in at least one further process stage from a second portion of component A and a second portion of component B.

It is possible, for example, first to prepare at least one hydroxy-terminated prepolymer from a first portion of component A and a first portion of component B, and separately to prepare at least one NCO-terminated prepolymer from a second portion of component A and a second portion of component B. The first and second portions of component A may correspond to the total amount of component A, and the first and second portions of component B may correspond to the total amount of component B. It is also possible that, as well as the first and second portions of components A and B converted, there is also a further, unconverted portion of components A and/or B. The at least one hydroxy-terminated prepolymer can then be reacted with the at least one NCO-terminated prepolymer to give the thermoplastic polyurethane. If it should be the case that the total amount of component A and/or B has not been consumed in preparing the hydroxy-terminated prepolymer, NCO-terminated prepolymer and any non-reactively terminated prepolymer, the remaining portion of component A and/or B is reacted either with the reaction product that forms through the reaction of the prepolymers (hydroxy-terminated prepolymers, NCO-terminated prepolymers and non-reactively terminated prepolymers) with one another in a separate process stage or together with the prepolymers in one process stage to give the thermoplastic polyurethane. The reactants can be converted stepwise through the addition of any desired portions or in one step by addition of the total amount. The sequence of addition of the portions can be freely chosen. However, one preferable option is to initially charge the at least one hydroxy-terminated prepolymer and to add at least one NCO-terminated prepolymer thereto.

For example, the total amount of the at least one NCO-terminated prepolymer produced can be reacted all at once with the total amount of the at least one hydroxy-terminated prepolymer, or a portion of the at least one NCO-terminated prepolymer is first reacted with the total amount of the at least one hydroxy-terminated prepolymer and, in subsequent process stages, further portions of the at least one NCO-terminated prepolymer are added and converted.

It is likewise possible, for example, to react a first portion of the at least one NCO-terminated prepolymer with a first portion of the at least one hydroxy-terminated prepolymer and, in further subsequent process stages, to add and convert further portions until the total amount of the at least one hydroxy-terminated prepolymer generated and the total amount of the at least one NCO-terminated prepolymer generated have reacted.

Preferably, the at least one hydroxy-terminated prepolymer and the at least one NCO-terminated prepolymer are reacted in a molar ratio of 1.0:0.95 to 0.95:1.0, preferably in a molar ratio of 1.0:0.98 to 0.98:1.0.

In a particularly preferred embodiment, in this case, the OH- or NCO-functional prepolymers that form after the stepwise addition, at 25° C., are solids having a melting point of preferably >50° C., preferably >90° C., more preferably >120° C. and most preferably >140° C.

The number-average molar mass (Mₙ) of the thermoplastic polyurethane formed can be adjusted by the molecular ratio of components A and B used and/or via the conversion and/or via the use of chain terminators or via a combination of all the options. The correlation between the molecular ratio of components A and B, the content of chain terminators, the conversion and the achievable number-average molar mass is known to the person skilled in the art as the Carothers equation.

It will be clear to the person skilled in the art that the production of the thermoplastic polyurethane in the abovementioned embodiments can be effected in a multitude of process stages. Components C and D can independently be added here in individual process stages only or in all process stages.

In a further preferred embodiment of the process of the invention, components A and B and/or abovementioned prepolymers (hydroxy-terminated prepolymers, NCO-terminated prepolymers, non-reactively terminated prepolymers) and/or compatible mixtures thereof are supplied to the reaction mixture at a temperature at least 30 K, preferably at least 50 K and more preferably 100 K below that of the reaction mixture. This has the advantage that some of the enthalpy of reaction is removed by the heating of components A and B and/or abovementioned prepolymers.

The temperatures for formation of the thermoplastic polyurethane by reaction of the at least one hydroxy-terminated prepolymer with a second portion of component B in the process according to the invention may be selected depending on the compounds used. However, it is preferable here when the reaction is conducted at temperatures of ≥60° C. to ≤260° C., preferably of ≥80° C. to ≤250° C., more preferably of ≥100° C. to ≤245° C. and most preferably of ≥120° C. to ≤240° C. In this context, brief (<60 seconds) deviations in the reaction temperature from the abovementioned ranges experienced by the product during the reaction are tolerated.

If the thermoplastic polyurethane has a tendency to crystallize and has a melting point, the reaction is preferably conducted within a temperature range from 30 K below to 150 K above the melting point, preferably from 15 K below to 100 K above, more preferably from 10 K below to 70 K above, the melting point of the thermoplastic polyurethane.

In a further preferred embodiment of the process according to the invention, the at least one hydroxy-terminated prepolymer is prepared in at least one first process stage and is reacted in at least one second process stage with a second portion of component B, component A and/or the at least one NCO-terminated prepolymer to give the thermoplastic polyurethane, where the first process stage may have different reaction conditions with regard to temperature, pressure and/or shear rate compared to the at least one second process stage and the process stages are connected to one another via at least one mass-transferring conduit. The at least one NCO-terminated prepolymer is preferably prepared in a third process stage which is separate from the at least one first and second process stages and has different reaction conditions with regard to temperature, pressure and shear rate from the at least one first and second process stages and is connected to the at least one first or second process stage via at least one mass-transferring conduit.

In another embodiment, the at least one NCO-terminated prepolymer can also be prepared independently in the at least one second process stage and, on completion of conversion of the components to the at least one NCO-terminated prepolymer, can be reacted with the at least one hydroxy-terminated prepolymer in at least one third process stage to give the thermoplastic polyurethane.

If one of the prepolymers according to the invention has a tendency to crystallize and it has a melting point, the wall temperature of the apparatuses, according to the invention, is kept within a temperature range from 30 K below to 150 K above the melting point, preferably from 15 K below to 100 K above, more preferably from 10 K below to 70 K above, the respective melting point of the hydroxy-terminated prepolymer or of the optionally NCO-terminated prepolymer and/or of the optionally non-reactively terminated prepolymer or of a mixture of at least two of these, in the conversion stage.

In a preferred variant, the apparatus used for production of the at least one hydroxy-terminated prepolymer or of the at least one NCO-terminated prepolymer is a pumped circulation reactor in which components A and B are metered in in desired proportions and, optionally, components C and D are metered in in desired proportions, and in which the enthalpy of reaction that arises is removed in a heat transferrer. In a further preferred variant, a mixer-heat transferrer is used for conversion of the components, in which the reaction and the removal of heat take place at the same site.

The average residence time in the process stage suitable for formation of the thermoplastic polyurethane from the at least one hydroxy-terminated prepolymer is from 5 seconds to 60 minutes, preferably from 30 seconds to 60 minutes, more preferably from 1 minute to 50 minutes and most preferably from 10 minutes to 50 minutes.

For reaction of the at least one hydroxy-terminated prepolymer with a second portion of component B, of component A and/or of the at least one NCO-terminated prepolymer or any mixture thereof or a mixture of the respective components with at least one non-reactive prepolymer to give the thermoplastic polyurethane, it is necessary to match the process to the exponential rise in viscosity in this phase. For this purpose, preference is given to using apparatuses in which the product is actively moved by mechanical energy. Particular preference is given to using apparatuses in which the material surfaces clean one another—with allowance for clearance. Such apparatuses are, for example, co-rotating multi-screw extruders such as two-shaft or four-shaft extruders or ring extruders, co-rotating multi-screw extruders, co-kneaders or planetary roll extruders and rotor-stator systems. Further suitable apparatuses are single- or twin-shaft large-volume kneaders. The twin-shaft large-volume kneaders may be co- or counter-rotating. Examples of large-volume kneaders are, for example, CRP (from List Technology AG), Reacom (Buss-SMS-Canzler GmbH), Reasil (Buss-SMS-Canzler GmbH), KRC kneader (Kurimoto, Ltd). In a preferred embodiment, at least one apparatus of this kind is combined with at least one static mixer, dynamic mixer or mixer-heat transferrer, where the static mixer, dynamic mixer or mixer-heat transferrer produces a mixture of component B, of component A or of the at least one NCO-terminated prepolymer or of any desired mixture of these with the hydroxy-terminated prepolymer. If one of the components in the mixture has a tendency to crystallize, the temperature of the mixture is kept by suitable measures within a temperature range from 30 K below to 150 K above the melting point, preferably from 15 K below to 100 K above, more preferably from 10 K below to 70 K above, the melting point of the component that melts at the highest temperature or of the reaction product of the components that melts at the highest temperature. According to the invention, the residence time in the static mixer, dynamic mixer or mixer-heat transferrer is sufficiently short that the rise in viscosity (caused by the polyaddition reaction of the reactive components with one another) does not lead to blockage of the static mixer, dynamic mixer or mixer-heat transferrer and/or an increase in pressure is limited to <50 bar, preferably <30 bar, more preferably <20 bar and most preferably <10 bar, and the mixture formed is fed to an apparatus that corresponds to the list above. The ratio of the residence times in the static mixer, dynamic mixer or mixer-heat transferrer to those in the downstream apparatus is preferably from 1:100 to 1:2, more preferably from 1:50 to 1:5 and most preferably from 1:30 to 1:10. In a particular embodiment, the components may also take the form of a mixture with at least one non-reactive prepolymer.

In a further preferred embodiment, the final process stage takes place in an extruder.

In a further preferred embodiment, the final process stage takes place in a combination of a static mixer, dynamic mixer or mixer-heat transferrer with a heated conveyor belt.

In a further preferred embodiment, in the final process stage, at least two of the abovementioned apparatuses are combined, for example an extruder with a further extruder or an extruder with a large-volume kneader. In this execution, the ratio of the residence time in the first apparatus to that in the second apparatus is preferably from 1:100 to 1:2, more preferably from 1:50 to 1:3 and most preferably from 1:30 to 1:5.

In a further preferred version, in the final process stage, at least one of the abovementioned apparatuses is combined with a belt reactor, in which the product from one of the abovementioned apparatuses is applied to a circulating belt, where it is reacted further. If the thermoplastic polyurethane has a tendency to crystallize and has a melting point, the temperature of the product on the belt reactor is kept by suitable measures within a temperature range from 100 K below to 50 K above the melting point, preferably from 80 K below to 10 K above, more preferably from 50 K below to 10 K above the melting point, most preferably from 30 K below to 10 K above the melting point.

After the reaction to give the thermoplastic polyurethane, the product is converted to a commercial form, typically pellets. After the conversion in the final process stage, the product is in the molten state, is comminuted in the molten state and is made to solidify by cooling, or is first made to solidify by cooling and then comminuted. This can be accomplished, for example, by the methods of strand pelletization, underwater strand pelletization, water-ring pelletization and underwater pelletization that are known to the person skilled in the art. Cooling is preferably effected with water; cooling with air or other media is also possible.

After conversion in a belt reactor, the product can also be cooled, crushed and ground.

According to the invention, the thermoplastic polyurethane thus obtained can be mixed in a solid-state mixing process and melted and pelletized again in a further extruder. This is preferable particularly when product is cooled and ground downstream of the belt reactor because this operation also homogenizes the product form.

In a further preferred embodiment of the process according to the invention, a total throughput of polyurethane polymer of at least 0.5 kg/h is achieved. Preferably, a total throughput of polyurethane polymer of at least 2 kg/h, more preferably of at least 100 kg/h and most preferably of at least 1000 kg/h is achieved.

In a further preferred embodiment of the continuous solvent-free multistage process according to the invention, the process comprises the following steps:

i) continuously mixing the total amount or a first portion of component A with a first portion of component B and optionally components C and/or D,

ii) continuously reacting the mixture from step i) in at least one first process stage to form the at least one hydroxy-terminated prepolymer, where the temperature of the reaction mixture in the at least one first process stage is kept below the breakdown temperature of the at least one hydroxy-terminated prepolymer,

iii) continuously transferring the at least one hydroxy-terminated prepolymer formed in step ii) into a second process stage, where the second process stage is connected to the first process stage by at least one mass transfer conduit,

iv) optionally continuously mixing and reacting the remaining portions of components A and B in a third process stage in order to prepare at least one NCO-terminated prepolymer, where the temperature of the reaction mixture in the third process stage is kept below the breakdown temperature of the at least one NCO-terminated prepolymer, where the third process stage is connected to the first and/or second process stage via at least one mass transfer conduit,

v) continuously mixing the at least one hydroxy-terminated prepolymer with the remaining portion of component B and optionally with the remaining portion of component A and/or the at least one NCO-terminated prepolymer from step iv),

vi) continuously reacting the mixture from step v) to obtain the thermoplastic polyurethane, where the temperature of the reaction mixture in the process stage is kept below the breakdown temperature of the thermoplastic polyurethane,

vii) continuously cooling and pelletizing the thermoplastic polyurethane.

According to the invention, one or more diols are used as component A, where at least one diol of component A has a molecular weight of 62 g/mol to 250 g/mol. According to the invention, it is also possible to use a mixture of diols in which only a portion of the diols has a molecular weight of 62 g/mol to 250 g/mol and the remaining portion of the diols has a molecular weight of >250 g/mol, where the overall enthalpy of reaction over all process stages must be within the range claimed. The diols and/or the precursor compounds thereof may have been obtained from fossil or biological sources. The person skilled in the art is aware that the overall enthalpy of reaction in the reaction of a diisocyanate with various diols depends on the molecular weight of the diol. The reaction of 1,6-diisocyanatohexane, for example, with a short-chain diol, for example butane-1,4-diol, has a distinctly higher overall enthalpy of reaction than the reaction of 1,6-diisocyanatohexane, for example, with a long-chain diol, for example a polytetramethylene glycol polyol having a number-average molecular weight of 1000 g/mol. Examples of useful long-chain diols include polyester polyols, polyether polyols, polycarbonate polyols, poly(meth)acrylate polyols and/or polyurethane polyols.

If, for example, the reaction of one or more diisocyanates with a mixture of diols having a molecular weight of 62 g/mol to 250 g/mol and diols having a molecular weight of >250 g/mol should have an overall enthalpy of reaction over all process stages that is not within the range claimed, the person skilled in the art is aware that, for example by increasing the content of diols having a molecular weight of 62 g/mol to 250 g/mol and lowering the content of diols having a molecular weight of >250 g/mol in the mixture, the desired overall enthalpy of reaction can be adjusted such that it is within the range claimed.

In a preferred embodiment, 90 mol % to 100 mol % of the diols, preferably 95 mol % to 100 mol % of the diols, especially preferably 98 mol % to 100 mol % of the diols, even more preferably 99 mol % to 100 mol % of the diols, of component A have a molecular weight of 62 g/mol to 250 g/mol and, most preferably, the one or more diols of component A all have a molecular weight of 62 g/mol to 250 g/mol.

According to the invention, one or more difunctional alcohols, especially aliphatic, araliphatic or cycloaliphatic diols having molecular weights of 62 g/mol to 250 g/mol are used. These may be, for example, ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, decane-1,10-diol, undecane-1,11-diol, do decane-1,12-diol, cyclobutane-1,3-diol, cyclopentane-1,3-diol, cyclohexane-1,2-, -1,3- and -1,4-diol, cyclohexane-1,4-dimethanol, 2-cyclohexene-1,4-diol, 2-methylcyclohexane-1,4-diol, 2-ethylcyclohexane-1,4-diol, 2,2,4,4-tetramethylcyclobutane-1,3-diol, hydrogenated bisphenol A (2,2-bis(4-hydroxycyclohexyl)propane), cycloheptane-1,3-diol, cycloheptane-1,4-diol, 2-methylcycloheptane-1,4-diol, 4-methyl cycloheptane-1,3-diol, 4,4′-(1-methylethylidene)biscyclohexanol, cyclooctane-1,3-diol, cyclooctane-1,4-diol, cyclooctane-1,5-diol, 5-methyl cyclooctane-1,4-diol, 5-ethylcyclooctane-1,4-diol, 5-propylcyclooctane-1,4-diol and 5-butylcyclooctane-1,4-diol. It is also possible to use mixtures of the abovementioned alcohols. The diols and/or the precursor compounds thereof may have been obtained from fossil or biological sources. If component A is mentioned in the context of the present invention, this may also be a mixture of at least two components A or a mixture of component(s) A and non-reactively terminated prepolymers. It is preferably one component A or a mixture of at least two components A.

In a preferred embodiment, one or more aliphatic, cycloaliphatic and/or araliphatic diols are used as component A, preferably one or more aliphatic or cycloaliphatic diols, more preferably one or more aliphatic diols having a molecular weight of 62 g/mol to 250 g/mol, even more preferably selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-, -1,3- and -1,4-diol, cyclohexane-1,4-dimethanol, and/or mixtures of at least 2 of these. Preference is given to using aliphatic or cycloaliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-, -1,3- and -1,4-diol, cyclohexane-1,4-dimethanol, and/or mixtures of at least 2 of these. Preference is given to using, as component A, aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol and/or mixtures of at least 2 of these, preferably ethane-1,2-diol, prop ane-1,2-diol, propane-1,3-diol, butane-1,2-diol, butane-1,3-diol, butane-1,4-diol, pentane-1,5-diol, hexane-1,6-diol, heptane-1,7-diol and/or mixtures of at least 2 of these, more preferably butane-1,2-diol, butane-1,3-diol, butane-1,4-diol, pentane-1,5-diol, hexane-1,6-diol and/or mixtures of at least 2 of these, more preferably ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least 2 of these, even more preferably ethane-1,2-diol, propane-1,2-diol, propane-1,3-diol, butane-1,2-diol, butane-1,3-diol, butane-1,4-diol, pentane-1,5-diol and/or mixtures of at least 2 of these, and even more preferably ethane-1,2-diol, propane-1,2-diol, propane-1,3-diol, butane-1,2-diol, butane-1,3-diol, butane-1,4-diol, especially butane-1,4-diol and/or mixtures of at least 2 of these. The diols and/or the precursor compounds thereof may have been obtained from fossil or biological sources.

Preference is given to using, as component A, aliphatic, araliphatic or cycloaliphatic diols having a molecular weight of 62 g/mol to 250 g/mol, more preferably of 62 g/mol to 150 g/mol, even more preferably of 62 g/mol to 120 g/mol. Preference is given to using, as component A, aliphatic or cycloaliphatic diols having a molecular weight of 62 g/mol to 250 g/mol, more preferably of 62 g/mol to 150 g/mol, even more preferably of 62 g/mol to 120 g/mol. The diols and/or the precursor compounds thereof may have been obtained from fossil or biological sources.

The diisocyanates used as component B in accordance with the invention include aliphatic, cycloaliphatic and/or araliphatic diisocyanates. The person skilled in the art is aware that the overall enthalpy of reaction in the reaction of an aliphatic, cycloaliphatic and/or araliphatic diisocyanate with a diol is higher than the reaction of an araliphatic diisocyanate with the same diol. Therefore, it is also possible to use a mixture of one or more aliphatic, cycloaliphatic, araliphatic and/or araliphatic diisocyanates as component B, provided that the overall enthalpy of reaction over all the process stages is within the range claimed. If, for example, the reaction of a mixture of analiphatic diisocyanate and an aromatic diisocyanate with one or more diols should have an overall enthalpy of reaction over all the process stages that is not within the range claimed, the person skilled in the art is aware that, for example, by increasing the content of aliphatic diisocyanate and lowering the content of an aromatic diisocyanate in the mixture, the overall enthalpy of reaction desired can be adjusted such that it is within the range claimed. In a preferred embodiment, aromatic diisocyanates are used in proportions of up to 2 mol % based on the molar amount of component B.

Suitable components B are all aliphatic, cycloaliphatic, aromatic or araliphatic diisocyanates, especially monomeric diisocyanates, that are known to those skilled in the art. The diisocyanates and/or the precursor compounds thereof may have been obtained from fossil or biological sources. Preferably, 1,6-diisocyanatohexane (HDI) is produced from 1,6-hexamethylenediamine which is obtained from biological sources. Suitable compounds are preferably those from the molecular weight range of ≥140 g/mol to ≤400 g/mol, no matter whether these have been obtained by means of phosgenation or by phosgene-free methods. If component B is mentioned in the context of the present invention, this may also be a mixture of at least two components B or a mixture of component(s) B and non-reactively terminated prepolymers. It is preferably one component B or a mixture of at least two components B.

Examples of suitable aliphatic diisocyanates are 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane and 1,10-diisocyanatodecane.

Examples of suitable cycloaliphatic diisocyanates are 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12MDI), 1,3- and 1,4-bis(isocyanatomethyl)cyclohexane, bis(isocyanatomethyl)norbomane (NBDI), 4,4′-diisocyanato-3,3′-dimethyldicyclohexylmethane, 4,4′-diisocyanato-3,3′,5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′,5,5′-tetramethyl-1,1′-bi(cyclohexyl), 1,8-diisocyanato-p-menthane, 1,3-diisocyanatoadamantane and 1,3-dimethyl-5,7-diisocyanatoadamantane.

Examples of suitable aromatic diisocyanates are 2,4- and 2,6-diisocyanatotoluene (TDI), 2,4′- and 4,4′-diisocyanatodiphenylmethane (MDI) and 1,5-diisocyanatonaphthalene.

Examples of suitable araliphatic diisocyanates are 1,3- and 1,4-bis(isocyanatomethyl)benzene (xylylene diisocyanate; XDI), 1,3- and 1,4-bis(1-isocyanato-1-methylethyl)benzene (TMXDI).

Further diisocyanates that are likewise suitable can additionally be found, for example, in HOUBEN-WEYL “Methoden der organischen Chemie” [Methods of Organic Chemistry], volume E20 “Makromolekulare Stoffe” [Macromolecular Materials], Georg Thieme Verlag, Stuttgart, New York 1987, p. 1587-1593 or in Justus Liebigs Annalen der Chemie volume 562 (1949) p. 75-136.

Preference is given to using aliphatic and cycloaliphatic diisocyanates having a molecular weight of ≥140 g/mol to ≤400 g/mol, especially aliphatic and cycloaliphatic diisocyanates selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI) and/or mixtures of at least 2 of these. In another preferred embodiment, diisocyanates selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 1,8-diisocyanatooctane, 1,10-diisocyanatodecane, 1,3- and 1,4-diisocyanatocyclohexane, 1,3-diisocyanato-2-methylcyclohexane, 1-isocyanato-3,3,5-trimethyl-5-isocyanatomethylcyclohexane (isophorone diisocyanate; IPDI) and/or mixtures of at least 2 of these, even more preferably 1,4-diisocyanatobutane (BDI), 1,5-diisocyanatopentane (PDI), 1,6-diisocyanatohexane (HDI), 2-methyl-1,5-diisocyanatopentane and/or mixtures of at least 2 of these and even more preferably 1,4-diisocyanatobutane (BDI), 1,5-diisocyanatopentane (PDI), 1,6-diisocyanatohexane (HDI) and/or mixtures of at least 2 of these, are used.

In this connection, polyisocyanates are understood to mean organic compounds having more than two isocyanate groups, no matter whether these have been obtained by means of phosgenation or by phosgene-free methods. Examples of suitable polyisocyanates are triphenylmethane 4,4′,4″-triisocyanate or 4-isocyanatomethyloctane 1,8-diisocyanate (TIN).

In particular, it is also possible to use derivatives of the aliphatic, cycloaliphatic and/or araliphatic diisocyanates mentioned below. Examples of these are the commercially available trimers (biurets, allophanates or isocyanurates) of 1,4-diisocyanatobutane (BDI), 1,5-diisocyanatopentane (PDI), 1,6-diisocyanatohexane (HDI), 1-isocyanato-3,3,5-trimethyl-5-isocyanatomethylcyclohexane or 2,4′- and 4,4′-diisocyanatodicyclohexylmethane. These polyisocyanates can be added up to an amount at which the thermoplastic properties of the end product are conserved.

In a preferred embodiment, component B does not contain any aromatic diisocyanates, polyisocyanates and/or derivatives thereof.

For preparation of the thermoplastic polyurethanes, components A, B and the various prepolymers (hydroxy-terminated prepolymers, NCO-terminated prepolymers, non-reactively terminated prepolymers) can be converted in the process according to the invention optionally in the presence of one or more catalysts, auxiliaries and/or additives.

Suitable catalysts according to the invention are the customary tertiary amines known from the prior art, for example triethylamine, dimethylcyclohexylamine, N-methylmorpholine, N,N′-dimethylpiperazine, 2-(dimethylaminoethoxy)ethanol, diazabicyclo[2.2.2]octane and the like, and also in particular organic metal compounds such as titanic esters, iron compounds, tin compounds, e.g. tin diacetate, tin dioctoate, tin dilaurate or the dialkyltin salts of aliphatic carboxylic acids such as dibutyltin diacetate, dibutyltin dilaurate or the like. Preferred catalysts are organic metal compounds, in particular titanic esters, iron compounds and/or tin compounds.

The catalyst is used in amounts of 0.001% by weight to 2.0% by weight, preferably of 0.005% by weight to 1.0% by weight, more preferably of 0.01% by weight to 0.1% by weight, based on the diisocyanate component B. The catalyst can be used in neat form or dissolved in the diol component A. One advantage here is that the thermoplastic polyurethanes that are then obtained do not contain any impurities as a result of any catalyst solvents additionally used. The catalyst can be added in one or more portions or else continuously, for example with the aid of a suitable metering pump, over the entire duration of the reaction.

Alternatively, it is also possible to use mixtures of the catalyst(s) with a catalyst solvent, preferably with an organic catalyst solvent. The dilution level of the catalyst solutions can be chosen freely within a very wide range. Catalytically active solutions are those of a concentration over and above 0.001% by weight.

Suitable catalyst solvents are, for example, solvents that are inert toward isocyanate groups, for example hexane, toluene, xylene, chlorobenzene, ethyl acetate, butyl acetate, diethylene glycol dimethyl ether, dipropylene glycol dimethyl ether, ethylene glycol monomethyl or monoethyl ether acetate, diethylene glycol ethyl and butyl ether acetate, propylene glycol monomethyl ether acetate, 1-methoxyprop-2-yl acetate, 3-methoxy-n-butyl acetate, propylene glycol diacetate, acetone, methyl ethyl ketone, methyl isobutyl ketone, cyclohexanone, lactones such as β-propiolactone, γ-butyrolactone, ε-caprolactone and ε-methylcaprolactone, but also solvents such as N-methylpyrrolidone and N-methylcaprolactam, 1,2-propylene carbonate, methylene chloride, dimethyl sulfoxide, triethyl phosphate or any desired mixtures of such solvents.

Alternatively, in the process according to the invention, it is possible to use catalyst solvents that bear groups reactive toward isocyanates and can be incorporated into the diisocyanate. Examples of such solvents are mono- and polyhydric simple alcohols, for example methanol, ethanol, n-propanol, isopropanol, n-butanol, n-hexanol, 2-ethyl-1-hexanol, ethylene glycol, propylene glycol, the isomeric butanediols, 2-ethylhexane-1,3-diol or glycerol; ether alcohols, for example 1-methoxy-2-propanol, 3-ethyl-3-hydroxymethyloxetane, tetrahydrofurfuryl alcohol, ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, diethylene glycol, dipropylene glycol or else liquid higher molecular weight polyethylene glycols, polypropylene glycols, mixed polyethylene/polypropylene glycols and the monoalkyl ethers thereof; ester alcohols, for example ethylene glycol monoacetate, propylene glycol monolaurate, glycerol mono- and diacetate, glycerol monobutyrate or 2,2,4-trimethylpentane-1,3-diol monoisobutyrate; unsaturated alcohols, for example allyl alcohol, 1,1-dimethyl allyl alcohol or oleyl alcohol; araliphatic alcohols, for example benzyl alcohol; N-monosubstituted amides, for example N-methylformamide, N-methylacetamide, cyanoacetamide or 2-pyrrolidone, or any desired mixtures of such solvents.

As well as components A and B and the catalysts, it is also possible to use auxiliaries and/or additives. These may be standard additives in the field of thermoplastic technology, such as dyes, fillers, processing auxiliaries, plasticizers, nucleating agents, stabilizers, flame retardants, demoulding agents or reinforcing additives. Further details of the auxiliaries and additives mentioned can be found in the specialist literature, for example the monograph by J. H. Saunders and K. C. Frisch: “High Polymers”, volume XVI, Polyurethane, parts 1 and 2, Interscience Publishers 1962 and 1964, Taschenbuch für Kunststoff-Additive [Handbook of Plastics Additives] by R. Gachter and H. Müller (Hanser Verlag Munich 1990), or DE-A 29 01 774. It will be appreciated that it may likewise be advantageous to use multiple additives of multiple types.

In another preferred embodiment, additives used in small amounts may also be customary mono-, di-, tri- or polyfunctional compounds reactive toward isocyanates in proportions of 0.001 mol % up to 2 mol %, preferably of 0.002 mol % to 1 mol %, based on the total molar amount of component A, for example as chain terminators, auxiliaries or demoulding aids.

Examples include alcohols such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol and stearyl alcohol. Examples of suitable triols are trimethylolethane, trimethylolpropane or glycerol. Suitable higher-functionality alcohols are ditrimethylolpropane, pentaerythritol, dipentaerythritol or sorbitol. Amines such as butylamine and stearylamine or thiols are likewise suitable.

In the process according to the invention, in at least one stage in the multistage process, at least one hydroxy-terminated prepolymer is formed from the entirety or a first portion of component A and a first portion of component B. The at least one hydroxy-terminated prepolymer is obtained in the process according to the invention as an intermediate isolable in principle, by polyaddition of the diol component A with the diisocyanate component B, where the diol component A is in excess. The polyaddition can be effected in the presence of components C and D.

The at least one NCO-terminated prepolymer and the at least one non-reactively terminated prepolymer can be obtained as intermediates isolable in principle, by polyaddition of components A and B and optionally of the at least one chain terminator. The polyaddition can be effected in the presence of components C and D.

As well as the at least one hydroxy-terminated prepolymer, depending on the additives used, it is also possible to obtain non-reactively terminated prepolymers, or for them to be in a mixture with the hydroxy-terminated prepolymers. The NCO-terminated prepolymers may likewise be in the form of a mixture with the non-reactively terminated prepolymers. The non-reactive prepolymers have been formed from components A, B, optionally C and D. The non-reactive prepolymers are formed by preparation methods known to those skilled in the art. The non-reactive prepolymers can be prepared in the presence of component C. Preferably, the ratio of the non-reactive prepolymers to the hydroxy-terminated prepolymers and/or NCO-terminated prepolymers is <20:80% by weight, preferably <10:90% by weight, based in each case on the total weight of all hydroxy-terminated prepolymers and/or NCO-terminated prepolymers. The controlled mixing of non-reactively terminated prepolymers into the at least one hydroxy-terminated prepolymer has the advantage that the heat of reaction that occurs in the subsequent reaction of the at least one hydroxy-terminated prepolymer with a further portion of component B or with the at least one NCO-terminated prepolymer can be better controlled. In addition, the mixing-in of the non-reactively terminated prepolymers can affect the molecular weight distribution of the overall polyurethane according to the invention.

In a preferred embodiment of the process according to the invention, the at least one hydroxy-terminated prepolymer is formed by polyaddition of at least one combination of component A and B selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,4-diisocyanatobutane with heptane-1,7-diol, 1,4-diisocyanatobutane with octane-1,8-diol, 1,4-diisocyanatobutane with nonane-1,9-diol, 1,4-diisocyanatobutane with decane-1,10-diol, 1,4-diisocyanatobutane with cyclobutane-1,3-diol, 1,4-diisocyanatobutane with cyclopentane-1,3-diol, 1,4-diisocyanatobutane with cyclohexane-1,2-, -1,3- and -1,4-diol and/or mixtures of at least 2 isomers, 1,4-diisocyanatobutane with cyclohexane-1,4-dimethanol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,5-diisocyanatopentane with heptane-1,7-diol, 1,5-diisocyanatopentane with octane-1,8-diol, 1,5-diisocyanatopentane with cyclobutane-1,3-diol, 1,5-diisocyanatopentane with cyclopentane-1,3-diol, 1,5-diisocyanatopentane with cyclohexane-1,2-, -1,3- and -1,4-diol and/or mixtures of at least 2 isomers, 1,5-diisocyanatopentane with cyclohexane-1,4-dimethanol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol, 1,6-diisocyanatohexane with pentane-1,5-diol, 1,6-diisocyanatohexane with hexane-1,6-diol, 1,6-diisocyanatohexane with heptane-1,7-diol, 1-isocyanato-3,3,5-trimethyl-5-isocyanatomethylcyclohexane with ethane-1,2-diol and 1-isocyanato-3,3,5-trimethyl-5-isocyanatomethylcyclohexane with propane-1,2- and/or -1,3-diol. In a preferred embodiment of the process according to the invention, the at least one hydroxy-terminated prepolymer is formed by polyaddition of at least one combination of component A and component B selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,4-diisocyanatobutane with heptane-1,7-diol, 1,4-diisocyanatobutane with octane-1,8-diol, 1,4-diisocyanatobutane with cy clobutane-1,3-diol, 1,4-diisocyanatobutane with cyclopentane-1,3-diol, 1,4-diisocyanatobutane with cyclohexane-1,2-, -1,3- and -1,4-diol and/or mixtures of at least 2 isomers, 1,4-diisocyanatobutane with cyclohexane-1,4-dimethanol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,5-diisocyanatopentane with heptane-1,7-diol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol, 1,6-diisocyanatohexane with pentane-1,5-diol and 1,6-diisocyanatohexane with hexane-1,6-diol, even more preferably selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol and 1,6-diisocyanatohexane with pentane-1,5-diol, even more preferably selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,6-diisocyanatohexane with ethane-1,2-diol, 1,6-diisocyanatohexane with propane-1,2- and/or -1,3-diol and 1,6-diisocyanatohexane with butane-1,2-, -1,3- and/or -1,4-diol. In a further preferred embodiment of the process according to the invention, the at least one hydroxy-terminated prepolymer is formed by polyaddition of at least one combination of component A and component B selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,6-diisocyanatohexane with ethane-1,2-diol, 1,6-diisocyanatohexane with propane-1,2- and/or -1,3-diol and 1,6-diisocyanatohexane with butane-1,2-, -1,3- and/or -1,4-diol.

The invention likewise provides thermoplastic polyurethanes obtainable by the process according to the invention.

In a preferred embodiment, the thermoplastic polyurethane polymer has a proportion of component B of 30% by weight to 80% by weight, preferably of 40% by weight to 75% by weight, more preferably of 50% by weight to 70% by weight, most preferably of 55% by weight to 70% by weight.

In a preferred embodiment, the thermoplastic polyurethane polymer has a proportion of urethane groups of 4.0 mol/kg to 10.0 mol/kg of polymer, preferably of 6.0 mol/kg to 9.0 mol/kg of polymer, more preferably of 6.5 mol/kg to 9.0 mol/kg of polymer, most preferably of 7.0 mol/kg to 9.0 mol/kg of polymer. The proportion of urethane groups is determined by calculation from the molecular weight of the repeat unit.

In a further preferred embodiment, the thermoplastic polyurethane polymer from the process according to the invention is obtained by reaction of a diisocyanate component with 98% by weight to 100% by weight of aliphatic diisocyanates and at least one aliphatic and/or cycloaliphatic diol having a molecular weight of 62 g/mol to 250 g/mol. Preferably, the diisocyanate component contains solely aliphatic diisocyanates.

In a further preferred embodiment, the thermoplastic polyurethane polymer from the process according to the invention is prepared by reaction of a diisocyanate component B containing 98% by weight to 100% by weight of linear aliphatic diisocyanates and a diol component A containing 98% by weight to 100% by weight of linear aliphatic diols having a molecular weight of 62 g/mol to 250 g/mol. Particular preference is given to a polyurethane polymer prepared from a component B containing 98% by weight to 100% by weight of a diisocyanate, based on the total amount of component B, selected from the group consisting of hexamethylene 1,6-diisocyanate, pentamethylene 1,5-diisocyanate, butane 1,4-diisocyanate and/or a mixture of at least 2 of these, and a component A containing 98% by weight to 100% by weight of a diol, based on the total amount of component A, selected from the group consisting of butane-1,4-diol, hexane-1,6-diol, pentane-1,5-diol, propane-1,3-diol, ethane-1,2-diol and/or a mixture of at least 2 of these. Very particular preference is given to a polyurethane polymer prepared from a component B containing 98% by weight to 100% by weight of a diisocyanate, based on the total amount of component B, selected from the group consisting of hexamethylene 1,6-diisocyanate, pentamethylene 1,5-diisocyanate and/or a mixture of at least 2 of these, and a component A containing 98% by weight to 100% by weight of a diol, based on the total amount of component A, selected from the group consisting of butane-1,4-diol, hexane-1,6-diol, pentane-1,5-diol, propane-1,3-diol, ethane-1,2-diol and/or a mixture of at least 2 of these.

In a very particularly preferred embodiment, the thermoplastic polyurethane polymer is obtained from the process according to the invention by reaction of a diisocyanate component B containing 98% to 100% by weight of linear aliphatic diisocyanates, based on the total amount of component B, and a diol component A containing 98% to 100% by weight of linear aliphatic diols having a molecular weight of 62 g/mol to 250 g/mol, based on the total amount of component A. Particular preference is given to a polyurethane polymer that has been obtained from a component B containing 98% by weight to 100% by weight of hexamethylene 1,6-diisocyanate, based on the total amount of component B, and a component A containing 98% by weight to 100% by weight of butane-1,4-diol, based on the total amount of component A.

In a preferred embodiment, the product from the process according to the invention, in the CIE-Lab colour space, has an L* value of >70 and a b* value of <3, preferably an L* value of >75 and a b* value of <2, more preferably an L* value of >80 and a b* value of <1.5.

The colour values are determined with a Konica Minolta CMS spectrophotometer with the D 65 illuminant, 10° observer, according to DIN EN ISO 11664-1 (July 2011).

Preference is given to the following embodiments in particular:
1. A continuous solvent-free multistage process for preparing thermoplastic polyurethanes by reacting the following components:
   A) one or more diols,
   B) one or more diisocyanates including aliphatic, cycloaliphatic and/or araliphatic diisocyanates,
   C) optionally one or more catalysts, and
   D) optionally further auxiliaries or additives,
   where at least one diol of component A has a molecular weight of 62 g/mol to 250 g/mol, where at least one hydroxy-terminated prepolymer is formed from the total amount or a first portion of component A and a first portion of component B in at least one process stage of the multistage process, where the sum total of all portions of component A or the sum total of all portions of component B over all process stages of the multistage process together is the total amount of component A or component B used, characterized in that components A and B are selected such that, when they are converted in a molar ratio of 1.0:1.0, the overall enthalpy of reaction over all process stages is from −900 kJ/kg to −500 kJ/kg, determined to DIN 51007:1994-06.
2. The continuous solvent-free multistage process according to embodiment 1, characterized in that the overall enthalpy of reaction is determined according to DIN 517 June 1994 by heating 20 mg-30 mg of a mixture of component A and component B in a glass ampoule that has been sealed gas-tight at 3 K/min from −50° C. to +450° C., determining the difference between the temperature of the mixture and the temperature of an inert aluminium oxide reference by means of thermocouples, with component A and component B present in the mixture in a molar ratio of 1.0:1.0.
3. The continuous solvent-free multistage process according to either of the preceding embodiments, characterized in that, in at least one process stage, a portion of the overall enthalpy of reaction that arises, preferably of 25% to 98%, more preferably of 30% to 95% and even more preferably of 35% to 90% and most preferably of 40% to 85% of the overall enthalpy of reaction is removed.
4. The continuous solvent-free multistage process according to any of the preceding embodiments, characterized in that the overall enthalpy of reaction over all process stages is in the range from −900 kJ/kg to −550 kJ/kg, preferably in the range from −900 kJ/kg to −580 kJ/kg, more preferably in the range from −900 kJ/kg to −600 kJ/kg, even more preferably in the range from −900 kJ/kg to −650 kJ/kg.
5. The continuous solvent-free multistage process according to any of the preceding embodiments, characterized in that there is an overall molar ratio of component A to component B of 1.0:0.95 to 0.95:1.0.
6. The continuous solvent-free multistage process according to any of the preceding embodiments, characterized in that the average residence time in the at least one process stage for preparation of the hydroxy-terminated prepolymer is between 5 seconds and 90 minutes, preferably between 10 seconds and 60 minutes, more preferably between 30 seconds and 30 minutes, based in each case on one process stage.
7. The continuous solvent-free multistage process according to any of the preceding embodiments, characterized in that the at least one hydroxy-terminated prepolymer is formed in at least one process stage from the total amount of component A and a first portion of component B, preferably where the first portion of component B is from 40% to 95%, preferably from 60% to 95%, more preferably from 75% to 93%, based in each case on the total molar amount of component B used in the process.
8. The continuous solvent-free multistage process according to any of the preceding embodiments, characterized in that the at least one hydroxy-terminated prepolymer is formed in at least one process stage from a first portion of component A and a first portion of component B, where the molar ratio of the portions of components B and A used is from 0.65:1.0 to 0.98:1.0, preferably from 0.70:1.0 to 0.97:1.0, more preferably from 0.75:1.0 to 0.96:1.0 and most preferably 0.75:1.0 to 0.95:1.0, and where the first portion A used is at least 50%, preferably 70%, more preferably 90%, based on the total molar amount of component A used in the process.
9. The continuous solvent-free multistage process according to any of the preceding embodiments, characterized in that the at least one hydroxy-terminated prepolymer has an average OH functionality calculated from the functionalities of the reactants of 1.8 to 2.1, preferably 1.95 to 2.05, more preferably 1.97 to 2.0, most preferably 1.975 to 2.0, based in each case on the molar amount of the overall prepolymer mixture.
10. The continuous solvent-free multistage process according to any of the preceding embodiments, characterized in that, in at least one further process stage that follows the formation of the at least one hydroxy-terminated prepolymer, the at least one hydroxy-terminated prepolymer is reacted with a further portion of component B to give the thermoplastic polyurethane, preferably where the further portion of component B is from 5% to 60%, preferably from 5% to 40%, more preferably from 7% to 25%, based in each case on the total molar amount of component B used in the process, with the proviso that the sum total of all portions of component B used over all the process stages of the multistage process together is the total molar amount of component B used.
11. The continuous solvent-free multistage process according to any of the preceding embodiments, characterized in that, in at least one further process stage that follows the formation of the at least one hydroxy-terminated prepolymer, the at least one hydroxy-terminated prepolymer is reacted with a second portion of component B and a second portion of component A to give the thermoplastic polyurethane, with the proviso that the sum total of all portions of component A and the sum total of all portions of component B over all the process stages of the multistage process together is the total molar amount of component A or component B used.
12. The continuous solvent-free multistage process according to any of the preceding embodiments, characterized in that the at least one hydroxy-terminated prepolymer is formed in at least one process stage from a first portion of component A and a first portion of component B, and the, in at least one further process stage that follows the formation of the hydroxy-terminated prepolymer, the at least one hydroxy-terminated prepolymer is reacted with at least one NCO-terminated prepolymer to give the thermoplastic polyurethane, where the at least one NCO-terminated prepolymer is formed in at least one further process stage from a second portion of component A and a second portion of component B.
13. The continuous solvent-free multistage process according to embodiment 12, characterized in that the at least one hydroxy-terminated prepolymer and the at least one NCO-terminated prepolymer are reacted in a molar ratio of 1.0:0.95 to 0.95:1.0, preferably in a molar ratio of 1.0:0.98 to 0.98:1.0.
14. The continuous solvent-free multistage process according to any of the preceding embodiments, characterized in that the at least one hydroxy-terminated prepolymer is prepared in at least one first process stage and is reacted in at least one second process stage with a second portion of component B, component A and/or the at least one NCO-terminated prepolymer to give the thermoplastic polyurethane, where the first process stage may have different reaction conditions with regard to temperature, pressure and/or shear rate compared to the at least one second process stage and the process stages are connected to one another via at least one mass-transferring conduit, preferably where the at least one NCO-terminated prepolymer is prepared in a third process stage which is separate from the at least one first and second process stages and has different reaction conditions with regard to temperature, pressure and shear rate from the at least one first and second process stages and is connected to the at least one first or second process stage via at least one mass-transferring conduit.
15. The continuous solvent-free multistage process according to any of the preceding embodiments, characterized in that the average residence time in the process stage for formation of the thermoplastic polyurethane from the at least one hydroxy-terminated prepolymer is from 5 seconds to 60 minutes, preferably from 30 seconds to 60 minutes, more preferably from 1 minute to 50 minutes and most preferably from 10 minutes to 50 minutes.
16. The continuous solvent-free multistage process according to any of the preceding embodiments, characterized in that a total throughput of polyurethane polymer of at least 0.5 kg/h, preferably of 2 kg/h, more preferably of at least 100 kg/h and most preferably of at least 1000 kg/h is achieved.
17. The continuous solvent-free multistage process according to any of the preceding embodiments, wherein the process comprises the following steps:
   i) continuously mixing the total amount or a first portion of component A with a first portion of component B and optionally components C and/or D,
   ii) continuously reacting the mixture from step i) in at least one first process stage to form the at least one hydroxy-terminated prepolymer, where the temperature of the reaction mixture in the at least one first process stage is kept below the breakdown temperature of the at least one hydroxy-terminated prepolymer,
   iii) continuously transferring the at least one hydroxy-terminated prepolymer formed in step ii) into a second process stage, where the second process stage is connected to the first process stage by at least one mass transfer conduit,
   iv) optionally continuously mixing and reacting the remaining portions of components A and B in a third process stage in order to prepare at least one NCO-terminated prepolymer, where the temperature of the reaction mixture in the third process stage is kept below the breakdown temperature of the at least one NCO-terminated prepolymer, where the third process stage is connected to the first and/or second process stage via at least one mass transfer conduit,
   v) continuously mixing the at least one hydroxy-terminated prepolymer with the remaining portion of component B and optionally with the remaining portion of component A and/or the at least one NCO-terminated prepolymer from step iv),
   vi) continuously reacting the mixture from step v) to obtain the thermoplastic polyurethane, where the temperature of the reaction mixture in the process stage is kept below the breakdown temperature of the thermoplastic polyurethane,
   vii) continuously cooling and pelletizing the thermoplastic polyurethane.
18. The continuous solvent-free multistage process according to any of the preceding embodiments, characterized in that 90 mol % to 100 mol % of the diols, preferably 95 mol % to 100 mol % of the diols, especially preferably 98 mol % to 100 mol % of the diols, even more preferably 99 mol % to 100 mol % of the diols, of component A have a molecular weight of 62 g/mol to 250 g/mol and, most preferably, the one or more diols of component A all have a molecular weight of 62 g/mol to 250 g/mol.
19. The continuous solvent-free multistage process according to any of the preceding embodiments, characterized in that the one or more diols of component A all have a molecular weight of 62 g/mol to 250 g/mol, preferably a molecular weight of 62 g/mol to 150 g/mol, more preferably a molecular weight of 62 g/mol to 120 g/mol.
20. The continuous solvent-free multistage process according to any of the preceding embodiments, characterized in that one or more aliphatic, cycloaliphatic and/or araliphatic diols are used as component A, preferably one or more aliphatic or cycloaliphatic diols, more preferably one or more aliphatic diols having a molecular weight of 62 g/mol to 250 g/mol, even more preferably selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-, -1,3- and -1,4-diol, cyclohexane-1,4-dimethanol, and/or mixtures of at least 2 of these.
21. The continuous solvent-free multistage process according to any of the preceding embodiments, characterized in that aliphatic or cycloaliphatic diols are used as component A, selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-, -1,3- and -1,4-diol, cyclohexane-1,4-dimethanol, and/or mixtures of at least 2 of these, preference being given to using, as component A, aliphatic diols selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol and/or mixtures of at least 2 of these, preferably ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol and/or mixtures of at least 2 of these, more preferably butane-1,2-diol, butane-1,3-diol, butane-1,4-diol, pentane-1,5-diol, hexane-1,6-diol and/or mixtures of at least 2 of these, more preferably ethane-1,2-diol, propane-1,2-diol, propane-1,3-diol, butane-1,2-diol, butane-1,3-diol, butane-1,4-diol, pentane-1,5-diol, hexane-1,6-diol and/or mixtures of at least 2 of these, even more preferably ethane-1,2-diol, propane-1,2-diol, propane-1,3-diol, butane-1,2-diol, butane-1,3-diol, butane-1,4-diol, pentane-1,5-diol and/or mixtures of at least 2 of these, and even more preferably ethane-1,2-diol, propane-1,2-diol, propane-1,3-diol, butane-1,2-diol, butane-1,3-diol, butane-1,4-diol, especially butane-1,4-diol and/or mixtures of at least 2 of these.
22. The continuous solvent-free multistage process according to any of the preceding embodiments, characterized in that one or more aliphatic or cycloaliphatic diisocyanates are used as component B, preferably selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI) and/or mixtures of at least 2 of these.
23. The continuous solvent-free multistage process according to any of the preceding embodiments, characterized in that aliphatic and cycloaliphatic diisocyanates having a molecular weight of ≥140 g/mol to ≤400 g/mol are used as component B.
24. The continuous solvent-free multistage process according to any of the preceding embodiments, characterized in that component B contains aromatic diisocyanates in proportions up to 2 mol % based on the total molar amount of component B.
25. The continuous solvent-free multistage process according to any of the preceding embodiments, characterized in that diisocyanates are used as component B, selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 1,8-diisocyanatooctane, 1,10-diisocyanatodecane, 1,3- and 1,4-diisocyanatocyclohexane, 1,3-diisocyanato-2-methylcyclohexane, 1-isocyanato-3,3,5-trimethyl-5-isocyanatomethylcyclohexane (isophorone diisocyanate; IPDI) and/or mixtures of at least 2 of these, even more preferably 1,4-diisocyanatobutane (BDI), 1,5-diisocyanatopentane (PDI), 1,6-diisocyanatohexane (HDI), 2-methyl-1,5-diisocyanatopentane and/or mixtures of at least 2 of these and even more preferably 1,4-diisocyanatobutane (BDI), 1,5-diisocyanatopentane (PDI), 1,6-diisocyanatohexane (HDI) and/or mixtures of at least 2 of these.
26. The continuous solvent-free multistage process according to any of the preceding embodiments, characterized in that the at least one hydroxy-terminated prepolymer is formed by polyaddition of at least one combination of component A and component B selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,4-diisocyanatobutane with heptane-1,7-diol, 1,4-diisocyanatobutane with octane-1,8-diol, 1,4-diisocyanatobutane with nonane-1,9-diol, 1,4-diisocyanatobutane with decane-1,10-diol, 1,4-diisocyanatobutane with cyclobutane-1,3-diol, 1,4-diisocyanatobutane with cyclopentane-1,3-diol, 1,4-diisocyanatobutane with cyclohexane-1,2-, -1,3- and -1,4-diol and/or mixtures of at least 2 isomers, 1,4-diisocyanatobutane with cyclohexane-1,4-dimethanol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,5-diisocyanatopentane with heptane-1,7-diol, 1,5-diisocyanatopentane with octane-1,8-diol, 1,5-diisocyanatopentane with cyclobutane-1,3-diol, 1,5-diisocyanatopentane with cyclopentane-1,3-diol, 1,5-diisocyanatopentane with cyclohexane-1,2-, -1,3- and -1,4-diol and/or mixtures of at least 2 isomers, 1,5-diisocyanatopentane with cyclohexane-1,4-dimethanol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol, 1,6-diisocyanatohexane with pentane-1,5-diol, 1,6-diisocyanatohexane with hexane-1,6-diol, 1,6-diisocyanatohexane with heptane-1,7-diol, 1-isocyanato-3,3,5-trimethyl-5-isocyanatomethylcyclohexane with ethane-1,2-diol and 1-isocyanato-3,3,5-trimethyl-5-isocyanatomethylcyclohexane with propane-1,2- and/or -1,3-diol, preferably selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,4-diisocyanatobutane with heptane-1,7-diol, 1,4-diisocyanatobutane with octane-1,8-diol, 1,4-diisocyanatobutane with cyclobutane-1,3-diol, 1,4-diisocyanatobutane with cyclopentane-1,3-diol, 1,4-diisocyanatobutane with cyclohexane-1,2-, -1,3- and -1,4-diol and/or mixtures of at least 2 isomers, 1,4-diisocyanatobutane with cyclohexane-1,4-dimethanol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,5-diisocyanatopentane with heptane-1,7-diol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol, 1,6-diisocyanatohexane with pentane-1,5-diol and 1,6-diisocyanatohexane with hexane-1,6-diol, even more preferably selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol and 1,6-diisocyanatohexane with pentane-1,5-diol, even more preferably selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,6-diisocyanatohexane with ethane-1,2-diol, 1,6-diisocyanatohexane with propane-1,2- and/or -1,3-diol and 1,6-diisocyanatohexane with butane-1,2-, -1,3- and/or -1,4-diol, and most preferably from 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,6-diisocyanatohexane with ethane-1,2-diol, 1,6-diisocyanatohexane with propane-1,2- and/or -1,3-diol and 1,6-diisocyanatohexane with butane-1,2-, -1,3- and/or -1,4-diol.
27. The continuous solvent-free multistage process according to any of the preceding embodiments, characterized in that the thermoplastic polyurethane polymer has a proportion of urethane groups of 4.0 mol/kg to 10.0 mol/kg of polymer, preferably of 6.0 mol/kg to 9.0 mol/kg of polymer, more preferably of 6.5 mol/kg to 9.0 mol/kg of polymer, most preferably of 7.0 mol/kg to 9.0 mol/kg of polymer.
28. The continuous solvent-free multistage process according to any of the preceding embodiments, characterized in that the thermoplastic polyurethane polymer is obtained by reaction of a diisocyanate component B containing 98% to 100% by weight of linear aliphatic diisocyanates, based on the total amount of component B, and a diol component A containing 98% to 100% by weight of linear aliphatic diols having a molecular weight of 62 g/mol to 250 g/mol, based on the total amount of component A.
29. The continuous solvent-free multistage process according to any of the preceding embodiments, characterized in that the thermoplastic polyurethane polymer is obtained by reaction of component B containing 98% to 100% by weight of a diisocyanate, based on the total amount of component B, selected from the group consisting of hexamethylene 1,6-diisocyanate, pentamethylene 1,5-diisocyanate, butane 1,4-diisocyanate and/or a mixture of at least 2 of these, and a component A containing 98% to 100% by weight of a diol, based on the total amount of component A, selected from the group consisting of butane-1,4-diol, hexane-1,6-diol, pentane-1,5-diol, propane-1,3-diol, ethane-1,2-diol and/or a mixture of at least 2 of these.
30. Thermoplastic polyurethane obtainable from the continuous solvent-free multistage process according to any of the preceding embodiments.
31. Thermoplastic polyurethane according to embodiment 30, characterized in that the thermoplastic polyurethane polymer has a proportion of urethane groups of 4.0 mol/kg to 10.0 mol/kg of polymer, preferably of 6.0 mol/kg to 9.0 mol/kg of polymer, more preferably of 6.5 mol/kg to 9.0 mol/kg of polymer, most preferably of 7.0 mol/kg to 9.0 mol/kg of polymer.

The thermoplastic polyurethanes produced by the process according to the invention can be processed to give shaped bodies, especially extruded articles, injection-moulded articles, films, thermoplastic foams, or powders.

The figures and examples elucidated hereinafter serve to further elucidate the invention, but these merely constitute illustrative examples of particular embodiments, and not a restriction of the scope of the invention. The individual figures show:

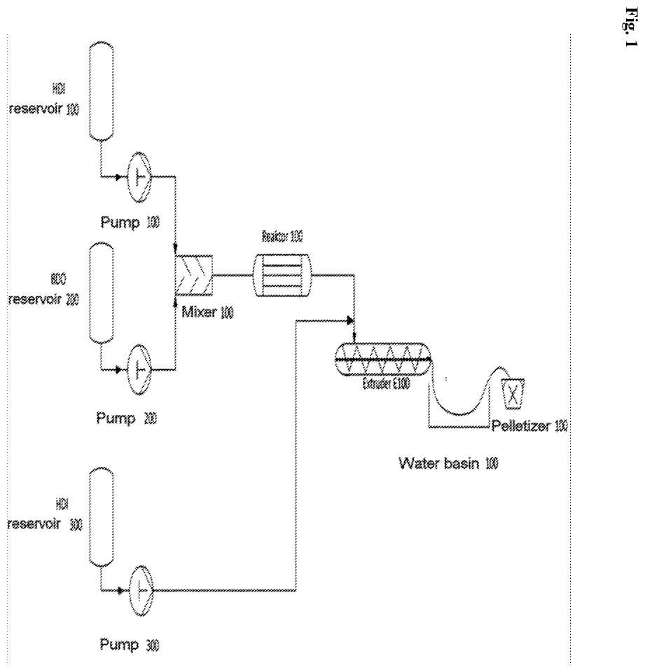

FIG. 1: Preferred embodiment of a construction for performance of a two-stage continuous preparation of a thermoplastic polyurethane according to the invention, by reaction sequence in a temperature-controlled polymerization reactor and extruder.

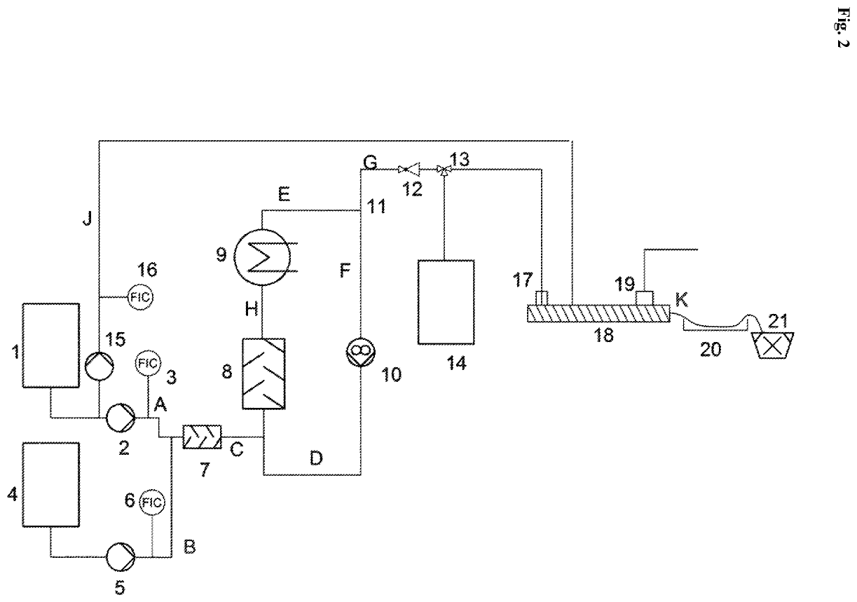

FIG. 2: Preferred embodiment of a construction for performance of a two-stage continuous preparation of a thermoplastic polyurethane according to the invention, by reaction sequence in a loop reactor and extruder.

### EXAMPLES

All percentages are based on weight, unless stated otherwise.

Raw materials used:

Hexamethylene 1,6-diisocyanate (HDI), pentamethylene 1,5-diisocyanate (PDI), isophorone diisocyanate (IPDI), 4,4′-diisocyanatodicyclohexylmethane (H12MDI) and xylylene diisocyanate (XDI) were sourced from Covestro AG.

Butane-1,4-diol (BDO) was sourced from Ashland. Propane-1,3-diol (PDO), hexane-1,6-diol (HDO) and cyclohexane-1,4-dimethanol were sourced from Sigma-Aldrich. The purity of each of the raw materials was ≥99%.

Colour Values

Colour values in the CIE-Lab colour space were determined with a Konica Minolta CMS spectrophotometer with the D 65 illuminant, 10° observer, according to DIN EN ISO 11664-1 (July 2011).

Differential Scanning Calorimetry (DSC)

Melting point was determined by means of DSC (differential scanning calorimetry) with a Mettler DSC 12E (Mettler Toledo GmbH, Giessen, Germany) in accordance with DIN EN 61006 (November 2004). Calibration was effected via the melt onset temperature of indium and lead. 10 mg of substance were weighed out in standard capsules. The measurement was effected by three heating runs from −50° C. to +200° C. at a heating rate of 20 K/min with subsequent cooling at a cooling rate of 20 K/min. Cooling was effected by means of liquid nitrogen. The purge gas used was nitrogen. The values reported are each based on the evaluation of the 2nd heating curve.

Screening by Differential Thermal Analysis (DTA)

The enthalpy data were ascertained by means of a screening DTA and conducted in an ISO 17025 accredited laboratory. The samples were weighed out in glass ampoules, sealed gas-tight and heated in the measuring instrument from −50° C. to +450° C. at 3 K/min. By means of thermocouples, the differential between the sample temperature and the temperature of an inert reference (aluminium oxide) was determined. The starting weight was 20 mg-30 mg. All measurements were conducted to DIN 51007 (June 1994). The measurement error of the instrument is ±2%.

TABLE 1
Enthalpies of reaction determined experimentally by DTA.
The molar ratio of diisocyanate component to diol
component in the determinations is 1.0:1.0.

| Diisocyanate | Diol | Energy [kJ/kg] |
|---|---|---|
| Inventive examples | | |
| hexamethylene 1,6-diisocyanate | butane-1,4-diol | −690 |
| hexamethylene 1,6-diisocyanate | hexane-1,6-diol | −550 |
| hexamethylene 1,6-diisocyanate: | butane-1,4-diol | −595 |
| l,4-bis(isocyanatomethyl)benzene | | |
| 80:20 | | |
| hexamethylene 1,6-diisocyanate: | butane-1,4-diol | −575 |
| isophorone diisocyanate | | |
| 80:20 | | |
| pentamethylene 1,5-diisocyanate | 1,4-butanediol: | −665 |
| | cyclohexane-1,4- | |
| | dimethanol 70:30 | |
| Comparative example | | |
| diphenylmethane | butane-1,4-diol | −465 |
| 4,4′-diisocyanate | | |

### Comparative Example 1

In housing 1 of a twin-shaft extruder (ZSK 53 from Werner&Pfleiserer), 64.4 kg/h of hexamethylene 1,6-diisocyanate, heated to 105° C., and a mixture of 22.8 kg/h of a poly-THF diol (1000 g/mol, from BASF) with 32.9 kg/h of butane-1,4-diol, heated to 110° C., were metered in. The extruder speed was 270 rpm. The residence time in the extruder was about 42 seconds. At the extruder outlet, the melt was filtered through a single-ply metal sieve with a mesh size of 200 micrometres, drawn off as a strand, cooled in a water bath and pelletized.

In spite of maximum cooling, the temperature in the extruder in 7 of 12 housings rose to values above 240° C. The product obtained had yellowish discolouration as a result of the significant heating and had dark brown to black specks and was thus commercially unusable.

### Comparative Example 2

A nitrogen-inertized 5 l pressure tank with an anchor stirrer, base outlet and internal thermometer was initially charged with butane-1,4-diol (1.35 kg) under nitrogen (1 bar), which was stirred until an internal temperature of 90° C. was attained. Over a period of 2 h, the total amount of hexamethylene 1,6-diisocyanate was then metered continuously into the pressure tank (2.5 kg), while the reactor temperature was simultaneously increased continuously up to 190° C. Owing to the heat of reaction released in the polyaddition, the temperature of the reaction mixture over the entire reaction time was up to 15° C. above the respective defined reactor temperature. After the addition of hexamethylene 1,6-diisocyanate had ended, the mixture was stirred at 200° C. for a further 10 minutes. During this time, a rise in the viscosity to 106 Pa*s (frequency of 1 Hz, rheometer: Anton Paar MCR-302; measurement to ISO 6721-10 (September 2015)) was detected. This rise in viscosity led to failure of the stirrer. Owing to the high viscosity, discharge of the polymer from the pressure tank was not possible.

The melting point of the polymer is 174.9° C. (DSC 2nd heating after cooling at 20 K/min).

### Comparative Example 3 (EP 0 135 111 A2)

EP 0 135 111 A2 discloses the preparation of thermoplastic polyurethanes by reaction of a polyester polyol, MDI, NDI, and butane-1,4-diol, hexane-1,6-diol and trimethylolpropane. A mixture of 3.72% by mass of 4,4′-MDI (x_{MDI}=0.0372) and 23.13% by mass of 1,5-NDI (x_{NDI}=0.2313) is reacted with different OH-terminated components. Complete conversion is assumed. 4,4′-MDI has a molecular mass of M_{m,MDI}=250.25 g/mol, and 1,5-NDI a molecular mass of M_{m,NDI}=210.19 g/mol.

The molar concentration of 4,4′-MDI is thus

$${c}_{MDI} = \frac{{x}_{MDI}}{{M}_{m , MDI}} = 0.1487 \frac{mol}{kg} ,$$

and the molar concentration of 1,5-NDI is

$${c}_{NDI} = \frac{{x}_{NDI}}{{M}_{m , NDI}} = 1.1004 \frac{mol}{kg} .$$

Since the molecules of 4,4′-MDI and 1,5-NDI each have two isocyanate groups, the concentration of the isocyanate end groups is

$${c}_{NCO} = 2 \cdot ( {c}_{NDI} + {c}_{MDI} ) = 2.4982 \frac{mol}{kg} \approx 2.5 \frac{mol}{kg} .$$

The molar enthalpy of reaction of the urethane per mole of isocyanate is about

$$Δ {h}_{m , NCO} = - 85 \frac{kJ}{mol} .$$

Thus, the mass-based enthalpy of reaction is

$$Δ h = {Δ h}_{m , NCO} \cdot {c}_{NCO} \sim - 212 \frac{kJ}{kg}$$

and hence is not within the inventive range.

### Comparative Example 4 (EP 0 900812A1, Examples 1-4)

EP 0 900812A1 discloses the preparation of thermoplastic polyurethanes by reaction of a polyester polyol or polyether polyol, MDI, and butane-1,4-diol and in some cases also hexane-1,6-diol. In examples 1-4, n_{PBA}=1.0 mol of polybutane-1,4-diol adipate (molecular mass reported as M_{m,PBA}=2200 g/mol), mass m_{PBA}=n_{PBA}·M_{m,PBA}=2.2 kg

n_{BDO}=2.5 mol of butane-1,4-diol (molecular mass M_{m,PBA}=90.12 g/mol), mass m_{BDO}=n_{BDO}·M_{m,BDO}=0.225 kg and

3.5 mol of 4,4′-MDI (molecular mass M_{m,MDI}=250.25 g/mol), mass m_{MDI}=n_{MDI}·M_{mMDI}=0.876 kg are used. The total mass of the reactive components is thus mᵣ=m_{PBA}+m_{BDO}+m_{MDI}=3.301 kg.

In addition, a proportion by mass of X_{gsA}=0.007 of bisethylenestearylamide, based on the total mass, was used. The total mass is thus

$${m}_{g e s} = \frac{{m}_{r}}{1 - {x}_{BSA}} = 3.3 \; 24 kg .$$

The molar concentration of 4,4′-MDI is

$${c}_{MDI} = \frac{{n}_{MDI}}{{m}_{ges}} = 1.05 \frac{mol}{kg}$$

Since one molecule of 4,4′-MDI has two isocyanate groups, the concentration of isocyanate end groups is

$${c}_{NCO} = 2 {c}_{MDI} = 2.1 \frac{mol}{kg} .$$

BSA The molar enthalpy of reaction of urethane reaction per mole of isocyanate is about

$${Δ h}_{m , NCO} = - 85 \frac{kJ}{mol} .$$

Thus, the mass-based enthalpy of reaction is

$$Δ h = Δ {h}_{m , NCO} \cdot {c}_{NCO} = - 179 \frac{kJ}{kg}$$

and is thus not within the inventive range.

### Comparative Example 5 (EP 0 900812A1, Examples 5-6)

In examples 5 and 6 of EP 0 900812A1, n_{PPEG}=0.4 mol of polypropylene ether glycol having a molecular mass of M_{m,PPEG}=2000 g/mol, i.e. a mass of m_{PPEG}=n_{PPEG}·M_{M,PPEG}=800 g, n_{PMEG}=0.6 mol of polytetramethylene ether glycol having a molecular mass of M_{m,PMEG}=1000 g/mol, i.e. a mass of m_{PMEG}=n_{PMEG}·M_{m,PMEG}=600 g, n_{BDO}=1.84 mol of butane-1,4-diol having a molecular mass of M_{m,BDO}=90.12 g/mol, i.e. a mass of m_{BDO}=n_{BDO} M_{m,BDO}=165.82 g, n_{HDO}=0.08 mol of hexane-1,6-diol having a molecular mass of M_{m,HDO}=118.18 g/mol, i.e. a mass of m_{HDO}=n_{HDO}·M_{M,HDO}=9.45 g, and n_{PPEG}=2.92 mol of 4,4′-MDI having a molecular mass of M_{m,MDI}=250.25 g/mol, i.e. a mass of m_{MDI}=n_{MDI}·M_{m,MDI}=730.73 g, were used.

The total mass of the reactive components was thus nt, =m_{PPEG} m_{PMEG} M_{BDO} M_{HDO}+m_{MDI}=2306 g.

In addition, a proportion by mass of X_{BSA}=0.007 of bisethylenestearylamide, based on the total mass, was used. The total mass is thus

$${m}_{ges} = \frac{{m}_{r}}{1 - {x}_{BSA}} = 2322 g .$$

The concentration of NDI is

$${c}_{MDI} = \frac{{n}_{MDI}}{{m}_{ges}} = 1.257 \frac{mol}{kg} .$$

Since one molecule of 4,4′-MDI has two isocyanate groups, the concentration of isocyanate end groups

$${c}_{NCO} = 2 {c}_{MDI} = 2.515 \frac{mol}{kg} .$$

The molar enthalpy of reaction of the urethane reaction per mole of isocyanate is about

$$Δ {h}_{m , NCO} = - 85 \frac{kJ}{mol} .$$

thus, the mass-based enthalpy of reaction is

$$Δ h = Δ {h}_{m , NCO} \cdot {c}_{NCO} = - 214 \frac{kJ}{kg}$$

thus not within the inventive range.

### Inventive Example 1 (FIG. 1)

FIG. 1 shows a schematic of the construction for performance of the two-stage continuous preparation of a thermoplastic polyurethane.

From reservoir 1, 311.7 g/h of hexamethylene 1,6-diisocyanate were conveyed into the mixer 100 with the pump 100 (model: SyrDos2 with 10 ml syringes from HiTec Zang). At the same time, from reservoir 2, 208.7 g/h of butane-1,4-diol were likewise conveyed into the mixer 100 with the pump 200 (model: SyrDos2 with 10 ml syringes from HiTec Zang). At room temperature, the two streams of matter were mixed in the mixer 100. The mixer used was a cascade mixer from Ehrfeld Microtechnik BTS GmbH which was heated by a heating band to a temperature of 200° C. At the outlet of the mixer, the mixture had a temperature of 100° C. The mixture was subsequently guided into the reactor 100 that had been heated to 170° C. (model: CSE-X/8G, Form G, internal diameter=12.3 mm, length=500 mm from Fluitec, heat exchange capacity of 60 kilowatts per cubic metre and Kelvin). The residence time in the reactor was 5 min. The prepolymer continuously exiting from reactor 100 was transferred through a pipeline heated to 200° C. into the second housing of a 2-shaft extruder (Miniextruder Process 11/Thermo Fisher). The extruder was heated to 200° C. over its entire length, and the speed of the shafts was 100 rpm. Subsequently, 70.1 g/h of hexamethylene 1,6-diisocyanate were conveyed into housing 3 of the extruder with the pump 300 (model: SyrDos2 with 10 ml syringes from HiTec Zang). The resultant milky-white product was discharged through the extruder nozzles, drawn off as a strand, cooled in a water bath (25° C.) and pelletized.

The average residence time over all process stages was about 6 minutes.

The temperature of the heating medium at the entrance to the reactor 100 was 170° C. The product temperature at the exit of the reactor 100 was 172° C. 71% of the overall enthalpy of reaction was thus removed in reactor 100.

The melting point of the polymer prepared is 182.9° C. (DSC 2nd heating after cooling at 20 K/min). The L* value is 82.7; the b* value is 0.2.

### Inventive Example 2

In an experimental setup as described in Example 1, 311.7 g/h of hexamethylene 1,6-diisocyanate were metered in with pump 100, 273.7 g/h of hexane-1,6-diol with pump 200, and 70.1 g/h of hexamethylene 1,6-diisocyanate with pump 300, and were reacted. The temperature at the inlet to the reactor 100 was 50° C. The heating medium temperature of the reactor 100 was 170° C. The temperature at the outlet was 176° C. 61% of the overall enthalpy of reaction was thus removed in the reactor 100.

The average residence time over all process stages was about 6 minutes. The melting point of the polymer prepared is 168.6° C. (DSC 2nd heating after cooling at 20 K/min).

### Inventive Example 3

In an experimental setup as described in Example 1, 311.7 g/h of hexamethylene 1,6-diisocyanate were metered in with pump 100, 240.2 g/h of pentane-1,5-diol with pump 200, and 73.9 g/h of hexamethylene 1,6-diisocyanate with pump 300, and were reacted. The temperature at the inlet to the reactor 100 was 100° C. The heating medium temperature of the reactor 100 was 155° C. The temperature at the outlet was 160° C. 70% of the overall enthalpy of reaction was thus removed in the reactor 100.

The average residence time over all process stages was about 6 minutes. The melting point of the polymer prepared is 152.7° C. (DSC 2nd heating after cooling at 20 K/min).

### Inventive Example 4

In an experimental setup as described in Example 1, 311.7 g/h of hexamethylene 1,6-diisocyanate were metered in with pump 100, 176.1 g/h of propane-1,3-diol with pump 200, and 73.9 g/h of hexamethylene 1,6-diisocyanate with pump 300, and were reacted. The temperature at the inlet to the reactor 100 was 162° C. The heating medium temperature of the reactor 100 was 165° C.; the temperature at the outlet was 168° C. 76% of the enthalpy of reaction was thus removed in the reactor 100.

The average residence time over all process stages was about 7 minutes. The melting point of the polymer prepared is 161.8° C. (DSC 2nd heating after cooling at 20 K/min).

### Inventive Example 5

In an experimental setup as described in Example 1, 285.7 g/h of pentamethylene 1,5-diisocyanate were metered in with pump 100, 176.2 g/h of propane-1,3-diol with pump 200, and 64.3 g/h of pentamethylene 1,5-diisocyanate with pump 300, and were reacted. The temperature at the inlet to the reactor 100 was 130° C. The heating medium temperature of the reactor 100 was 150° C.; the temperature at the outlet was 152° C. 78% of the enthalpy of reaction was thus removed in the reactor 100.

The average residence time over all process stages was about 7 minutes. The melting point of the polymer prepared is 153.3° C. (DSC 2nd heating after cooling at 20 K/min).

### Inventive Example 6

In an experimental setup as described in Example 1, 285.7 g/h of pentamethylene 1,5-diisocyanate were metered in with pump 100, 208.7 g/h of butane-1,4-diol with pump 200, and 67.8 g/h of pentamethylene 1,5-diisocyanate with pump 300, and were reacted.

The temperature at the inlet to the reactor 100 was 30° C. The heating medium temperature of the reactor 100 was 176° C.; the temperature at the outlet was 180° C. 78% of the enthalpy of reaction was thus removed in the reactor 100. 61% of the enthalpy of reaction was thus removed in the reactor 100.

The average residence time over all process stages was about 7 minutes. The melting point of the polymer prepared is 160.9° C. (DSC 2nd heating after cooling at 20 K/min). The L* value is 81.5; the b* value is 0.7.

### Inventive Example 7

In an experimental setup as described in Example 1, 311.7 g/h of hexamethylene 1,6-diisocyanate were metered in with pump 100, 192.5 g/h of a mixture of butane-1,4-diol and propane-1,3-diol (molar amount 1:1) with pump 200, and 70.1 g/h of hexamethylene 1,6-diisocyanate with pump 300, and were reacted. The temperature at the inlet to the reactor 100 was 90° C. The heating medium temperature of the reactor 100 was 135° C.; the temperature at the outlet was 140° C. 75% of the enthalpy of reaction was thus removed in the reactor 100.

The average residence time over all process stages was about 7 minutes. The melting point of the polymer prepared is 137.0° C. (DSC 2nd heating after cooling at 20 K/min).

### Inventive Example 8

In an experimental setup as described in Example 1, 305.5 g/h of pentamethylene 1,5-diisocyanate were metered in with pump 100, 259.1 g/h of a mixture of butane-1,4-diol and cyclohexane-1,4-dimethanol (molar amount 7:3) with pump 200, and 68.4 g/h of pentamethylene 1,5-diisocyanate with pump 300, and were reacted. The temperature at the inlet to the reactor 100 was 60° C. The heating medium temperature of the reactor 100 was 175° C.; the temperature at the outlet was 180° C. 64% of the enthalpy of reaction was thus removed in the reactor 100.

The average residence time over all process stages was about 6 minutes. The melting point of the polymer prepared is 166.1° C. (DSC 2nd heating after cooling at 20 K/min).

### Inventive Example 9

In an experimental setup as described in Example 1, 310.0 g/h of a mixture of hexamethylene 1,6-diisocyanate and m-xylylene diisocyanate (molar amount 8:2) were metered in with pump 100, 208.1 g/h of butane-1,4-diol with pump 200, and 83.9 g/h of a mixture of hexamethylene 1,6-diisocyanate and m-xylylene diisocyanate (molar amount 8:2) with pump 300, and were reacted. The temperature at the inlet to the reactor 100 was 40° C. The heating medium temperature of the reactor 100 was 176° C.; the temperature at the outlet was 180° C. 61% of the enthalpy of reaction was thus removed in the reactor 100.

The average residence time over all process stages was about 7 minutes. The melting point of the polymer prepared is 163.6° C. (DSC 2nd heating after cooling at 20 K/min).

### Inventive Example 10

In an experimental setup as described in Example 1, 313.3 g/h of a mixture of hexamethylene 1,6-diisocyanate and isophorone diisocyanate (molar amount 8:2) were metered in with pump 100, 208.1 g/h of butane-1,4-diol with pump 200, and 96.1 g/h of a mixture of hexamethylene 1,6-diisocyanate and isophorone diisocyanate (molar amount 8:2) with pump 300, and were reacted. The temperature at the inlet to the reactor 100 was 40° C. The heating medium temperature of the reactor 100 was 174° C.; the temperature at the outlet was 180° C. 61% of the enthalpy of reaction was thus removed in the reactor 100.

The average residence time over all process stages was about 6 minutes. The melting point of the polymer prepared is 163.7° C. (DSC 2nd heating after cooling at 20 K/min).

### Inventive Example 11 (FIG. 2)

From a 250 litre reservoir for hexamethylene 1,6-diisocyanate 1, with the aid of a toothed ring pump 2 (from HNP, MZR 7255), a hexamethylene 1,6-diisocyanate stream A was conveyed to a static mixer 7. The throughput of the hexamethylene 1,6-diisocyanate stream A was measured by means of a mass flow meter 3 (from Bronkhorst, Mini Cori-Flow M1X, max. flow rate 12 kg/h) and adjusted to a value of 2.911 kg/h. From a 250 litre reservoir for butane-1,4-diol 4, with the aid of a toothed ring pump 5 (from HNP, MZR 7205), a butane-1,4-diol stream B was conveyed to the static mixer 7. The throughput of the butane-1,4-diol stream was measured by means of a mass flow meter 6 (from Bronkhorst, Mini Con-Flow M1X, max. flow rate 8 kg/h) and adjusted to a value of 2.000 kg/h. The temperature of the hexamethylene 1,6-diisocyanate was ambient temperature, about 25° C. The temperature of the butane-1,4-diol was 40° C. In the static mixer 7 (Sulzer SMX, diameter 6 mm, ratio of length to diameter L/D=10), the hexamethylene 1,6-diisocyanate stream A and the butane-1,4-diol stream B were mixed with one another. This is stream C.

The mixed and dispersed stream C was mixed in a circulation system with a circulating polymer stream D in a static mixer 8 (static mixer equivalent to Sulzer SMX, internal diameter 34 mm, L/D=20) to give a stream H. The temperature of stream D was 182° C.

The mixed and already partly reacted stream H was guided into a temperature-controllable static mixer 9. The reaction proceeds there for the most part, and the heat of reaction that arose was removed. The temperature-controllable static mixer 9 was of similar construction to a Sulzer SMX reactor with internal crossed tubes. It had an internal volume of 1.9 litres and a heat exchange area of 0.44 square metres. It was heated/cooled with heat carrier oil. The heating medium temperature at the inlet was 180° C.

The product stream left the temperature-controllable static mixer 9 as a largely reacted stream E with a temperature of 183° C. At a branch 11, stream E was split into two substreams F and G. The pressure of substream F was increased at a gear pump 10. Substream F became the abovementioned substream D downstream of the pump.

The gear pump 10 (from Witte Chem 25,6-3) had a volume per cycle of 25.6 cubic centimetres and a speed of 50 per minute.

The whole circulation system was full, and the polymer was largely incompressible. Therefore, the mass flow rate of stream G was identical to that of stream C. Stream G consisted of oligomer.

The whole circulation system consisted of jacketed pipelines and apparatuses that were heated with thermal oil. The heating medium temperature was 182° C.

Downstream of the pressure-retaining valve 12, stream G was run past a three-way valve 13. On startup and shutdown or in the event of faults, it was possible to run said stream G to a waste vessel 14, an open 200 litre metal vat with air extraction. In regular operation, stream G was guided to an extruder 18.

From the hexamethylene 1,6-diisocyanate reservoir 1, with the aid of a micro toothed ring pump 15 (MZR 6355 from HNP), a hexamethylene 1,6-diisocyanate stream J was withdrawn. The throughput of the hexamethylene 1,6-diisocyanate stream J was measured by means of a mass flow meter 16 (from Bronkhorst, Mini Cori-Flow M1X, maximum flow rate 2 kg/h) and adjusted to 0.784 kilogram per hour. The temperature of the hexamethylene 1,6-diisocyanate stream J was likewise room temperature, about 25° C. This stream was likewise guided to the extruder 18.

The extruder 18 was a ZSK 26 MC from Coperion, which was operated at temperatures of 200° C. and a speed of 66 revolutions per minute. In this extruder, stream G, by means of a venting system 17 that was operated at a reduced pressure of about 1 mbar relative to ambient pressure, was freed of any inert gases entrained with streams of matter A and B and of possible volatile reaction products. Downstream of the addition of the oligomer stream G, the hexamethylene 1,6-diisocyanate stream J was added and the reaction to give the polymer was conducted. Before the end of the extruder, the resulting polymer stream was freed of volatile constituents via a degassing operation 19. The pressure in this degassing was 200 mbar below ambient pressure. The polymer stream K was expressed through two nozzles, cooled in a water bath filled with demineralized water, and chopped into pellets by means of a pelletizer 21.

The average residence time over all process stages was 51 minutes. The melting point of the polymer is 185.2° C. (DSC 2nd heating after cooling at 20 K/min).

58% of the overall enthalpy of reaction was removed in the temperature-controllable static mixer 9.

### Inventive Example 12 (FIG. 2)

In an experimental setup as described in Example 11, on this occasion, 2.711 kg/h of pentamethylene 1,5-diisocyanate (stream A) were conveyed into the static mixer 7 from reservoir 1, and 2.000 kg/h of butane-1,4-diol (stream B) from reservoir 4. The throughput of the pentamethylene 1,5-diisocyanate stream J was adjusted to 0.677 kilogram per hour.

The temperatures of the raw materials and the temperatures of the other streams of matter and of the plant components and heating media corresponded to those as described in Example 11. The extruder speed and the degassing pressures also corresponded to those in Example 11. The heating temperatures were 165° C.

The average residence time over all process stages was 53 minutes. The melting point of the polymer prepared is 159.0° C. (DSC 2nd heating after cooling at 20 K/min). 62% of the overall enthalpy of reaction was removed in the temperature-controllable static mixer 9.

1. A continuous solvent-free multistage process for preparing thermoplastic polyurethanes by reacting the following components:
A) one or more diols,
B) one or more diisocyanates including aliphatic, cycloaliphatic and/or araliphatic diisocyanates,
C) optionally one or more catalysts, and
D) optionally further auxiliaries or additives,
where at least one of the one or more diols of component A has a molecular weight of from 62 g/mol to 250 g/mol, wherein at least one hydroxy-terminated prepolymer is formed from a total amount or a first portion of component A and a first portion of component B in at least one process stage of the multistage process, wherein a sum total of all portions of component A or a sum total of all portions of component B over all process stages of the multistage process together is a total amount of component A or component B used,
wherein components A and B are selected such that, when they are converted in a molar ratio of 1.0:1.0, the overall enthalpy of reaction over all process stages is from −900 kJ/kg to −500 kJ/kg as determined according to DIN 51007:1994-06.

2. The continuous solvent-free multistage process as claimed in claim 1, wherein a portion of the overall enthalpy of reaction formed in at least one process stage is removed.

3. The continuous solvent-free multistage process as claimed in claim 1, wherein the overall enthalpy of reaction over all process stages is in the range from −900 kJ/kg to −550 kJ/kg.

4. The continuous solvent-free multistage process as claimed in claim 1, wherein there is an overall molar ratio of component A to component B of 1.0:0.95 to 0.95:1.0.

5. The continuous solvent-free multistage process as claimed in claim 1, wherein the at least one hydroxy-terminated prepolymer is formed in at least one process stage from the total amount of component A and a first portion of component B.

6. The continuous solvent-free multistage process as claimed in claim 1, wherein the at least one hydroxy-terminated prepolymer is formed in at least one process stage from a first portion of component A and a first portion of component B, where the molar ratio of the portions of component B to component A used is from 0.65:1.0 to 0.98:1.0, based on the total molar amount of component A used in the process.

7. The continuous solvent-free multistage process as claimed in claim 1, wherein the at least one hydroxy-terminated prepolymer is reacted with a further portion of component B to give the thermoplastic polyurethane in at least one further process stage that follows the formation of the at least one hydroxy-terminated prepolymer.

8. The continuous solvent-free multistage process as claimed in claim 1, wherein the at least one hydroxy-terminated prepolymer is formed in at least one process stage from a first portion of component A and a first portion of component B, wherein the at least one hydroxy-terminated prepolymer is reacted with at least one NCO-terminated prepolymer to give the thermoplastic polyurethane in at least one further process stage that follows the formation of the hydroxy-terminated prepolymer, and wherein the at least one NCO-terminated prepolymer is formed in at least one further process stage from a second portion of component A and a second portion of component B.

9. The continuous solvent-free multistage process as claimed in claim 1, wherein one or more aliphatic or cycloaliphatic diisocyanates are used as component B.

10. The continuous solvent-free multistage process as claimed in claim 1, wherein one or more aliphatic diisocyanates are used as component B.

11. The continuous solvent-free multistage process as claimed in claim 1, wherein from 90 mol % to 100 mol % of the one or more diols of component A have a molecular weight of 62 g/mol to 250 g/mol.

12. The continuous solvent-free multistage process as claimed in claim 1, wherein one or more aliphatic, cycloaliphatic and/or araliphatic diols are used as component A.

13. The continuous solvent-free multistage process as claimed in claim 1, wherein the at least one hydroxy-terminated prepolymer is formed by polyaddition of at least one combination of component A and component B selected from the group consisting of 1,4-diisocyanatobutane with ethane-1,2-diol, 1,4-diisocyanatobutane with propane-1,2- and/or -1,3-diol, 1,4-diisocyanatobutane with butane-1,2-, -1,3- and/or -1,4-diol, 1,4-diisocyanatobutane with pentane-1,5-diol, 1,4-diisocyanatobutane with hexane-1,6-diol, 1,4-diisocyanatobutane with heptane-1,7-diol, 1,4-diisocyanatobutane with octane-1,8-diol, 1,4-diisocyanatobutane with nonane-1,9-diol, 1,4-diisocyanatobutane with decane-1,10-diol, 1,4-diisocyanatobutane with cyclobutane-1,3-diol, 1,4-diisocyanatobutane with cyclopentane-1,3-diol, 1,4-diisocyanatobutane with cyclohexane-1,2-, -1,3- and -1,4-diol and/or mixtures of at least 2 isomers, 1,4-diisocyanatobutane with cyclohexane-1,4-dimethanol, 1,5-diisocyanatopentane with ethane-1,2-diol, 1,5-diisocyanatopentane with propane-1,2- and/or -1,3-diol, 1,5-diisocyanatopentane with butane-1,2-, -1,3- and/or -1,4-diol, 1,5-diisocyanatopentane with pentane-1,5-diol, 1,5-diisocyanatopentane with hexane-1,6-diol, 1,5-diisocyanatopentane with heptane-1,7-diol, 1,5-diisocyanatopentane with octane-1,8-diol, 1,5-diisocyanatopentane with cyclobutane-1,3-diol, 1,5-diisocyanatopentane with cyclopentane-1,3-diol, 1,5-diisocyanatopentane with cyclohexane-1,2-, -1,3- and -1,4-diol and/or mixtures of at least 2 isomers, 1,5-diisocyanatopentane with cyclohexane-1,4-dimethanol, 1,6-diisocyanatohexane with ethane-1,2-diol, 1,6-diisocyanatohexane with propane-1,2- and/or -1,3-diol, 1,6-diisocyanatohexane with butane-1,2-, -1,3- and/or -1,4-diol, 1,6-diisocyanatohexane with pentane-1,5-diol, 1,6-diisocyanatohexane with hexane-1,6-diol, 1,6-diisocyanatohexane with heptane-1,7-diol, 1-isocyanato-3,3,5-trimethyl-5-isocyanatomethylcyclohexane with ethane-1,2-diol and 1-isocyanato-3,3,5-trimethyl-5-isocyanatomethylcyclohexane with propane-1,2- and/or -1,3-diol.

14. The continuous solvent-free multistage process as claimed in claim 1, wherein an average residence time over all process stages is between 10 seconds and 110 minutes.

15. The continuous solvent-free multistage process as claimed in claim 1, wherein the multistage process achieves a total throughput of polyurethane polymer of at least 0.5 kg/h.

16. The continuous solvent-free multistage process as claimed in claim 1, wherein the process comprises:
i) continuously mixing the total amount or the first portion of component A with the first portion of component B and optionally components C and/or D,
ii) continuously reacting the reaction mixture from step i) in at least one first process stage to form the at least one hydroxy-terminated prepolymer, wherein a temperature of the reaction mixture in the at least one first process stage is kept below a breakdown temperature of the at least one hydroxy-terminated prepolymer,
iii) continuously transferring the at least one hydroxy-terminated prepolymer formed in step ii) into a second process stage, wherein the second process stage is connected to the first process stage by at least one mass transfer conduit,
iv) optionally continuously mixing and reacting the remaining portions of components A and B in a third process stage to prepare at least one NCO-terminated prepolymer, wherein a temperature of the reaction mixture in the third process stage is kept below a breakdown temperature of the at least one NCO-terminated prepolymer, wherein the third process stage is connected to the first and/or second process stage via at least one mass transfer conduit,
v) continuously mixing the at least one hydroxy-terminated prepolymer with the remaining portion of component B and optionally with the remaining portion of component A and/or the at least one NCO-terminated prepolymer from step iv),
vi) continuously reacting the mixture from step v) to obtain the thermoplastic polyurethane, wherein a temperature of the reaction mixture in the process stage is kept below a breakdown temperature of the thermoplastic polyurethane,
vii) continuously cooling and pelletizing the thermoplastic polyurethane.

17. A thermoplastic polyurethane obtained from the continuous solvent-free multistage process as claimed in claim 1.

18. The continuous solvent-free multistage process as claimed in claim 9, wherein the one or more aliphatic or cycloaliphatic diisocyanates used as component B are selected from the group consisting of 1,4-diisocyanatobutane (BDI), 1,5-diisocyanatopentane (PDI), 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI) and/or mixtures of at least 2 of these.

19. The continuous solvent-free multistage process as claimed in claim 12, wherein the one or more aliphatic, cycloaliphatic and/or araliphatic diols used as component A are selected from the group consisting of ethane-1,2-diol, propane-1,2-diol, propane-1,3-diol, butane-1,2-diol, butane-1,3-diol, butane-1,4-diol, pentane-1,5-diol, hexane-1,6-diol, heptane-1,7-diol, octane-1,8-diol, nonane-1,9-diol, cyclobutane-1,3-diol, cyclopentane-1,3-diol, cyclohexane-1,2-, -1,3- and -1,4-diol, cyclohexane-1,4-dimethanol, and/or mixtures of at least 2 of these.
